(19) United States
(12) Patent Application Publication
(10) Pub. No.: US 2020/0058953 A1
(43) Pub. Date: Feb. 20, 2020

(54) METHODS AND COMPOSITIONS FOR GOLD DENDRITE-BASED BIOSENSORS

(71) Applicant: Boston College, Chestnut Hill, MA (US)

(72) Inventors: Amy E. Valera, Somerville, MA (US); Nathan T. Nesbitt, Barre, MA (US); Michael J. Naughton, Chestnut Hill, MA (US); Thomas C. Chiles, Norfolk, MA (US)

(21) Appl. No.: 16/544,522

(22) Filed: Aug. 19, 2019

Related U.S. Application Data
(60) Provisional application No. 62/719,335, filed on Aug. 17, 2018.

(51) Int. Cl. H01M 10/056; H01B 1/12; H01M 10/058

(52) U.S. Cl. CPC H01M 10/056; H01B 1/122; H01M 10/052; H01M 2300/0094; H01M 10/058

(57) ABSTRACT

In one aspect, described are biosensors comprising a working electrode layer comprising a dendritic array comprising metallic dendrites having a conductive polymer layer. Systems are described using the disclosed biosensors useful for POC disease diagnosis, including, but not limited to, resource limited areas. Methods are described for making the disclosed biosensors which allow for improved control of dendritic growth using a pillared substrate, rather than a planar one. Also described are methods of using the disclosed biosensors to detect an analyte associated with a particular disease, e.g., an infectious disease. This abstract is intended as a scanning tool for purposes of searching in the particular art and is not intended to be limiting of the present disclosure.

### CROSS-REFERENCE TO RELATED APPLICATIONS

This Application claims the benefit of U.S. Provisional Application No. 62/719,335, filed on Aug. 17, 2018, which is incorporated herein by reference in its entirety.

### FIELD OF THE DISCLOSURE

The present disclosure is directed to a gold dendrite-based lab-on-a-chip biosensor for the detection of infectious disease biomarkers.

### BACKGROUND

The importance of POC diagnostic technologies has been highlighted by several recent high-profile infectious disease outbreaks. In 2017, Yemen's cholera epidemic became one of the largest and most rapidly spreading in modern history. While several factors have contributed to the severity of this and many other outbreaks, such as Ebola, a lack of rapid diagnostic tools and epidemiological monitoring cannot be ignored, as these are critical in controlling the spread of disease within human populations. Fecal culturing remains the benchmark of cholera diagnosis, but this method is a process which is both time-consuming, requiring a full day for cultures to develop, and necessitates clinical laboratory infrastructure. A more portable and rapid diagnostic tool exists, the Crystal VC Dipstick, but it suffers from a relatively high rate of false positives. There remains an unmet need for portable, real-time, cost effective detection methods, which exhibit specificity and sensitivity at the POC. Robust POC technologies can facilitate better prevention and earlier response, enabling accurate diagnosis and proper treatment, and thus improved patient prognosis and limited economic impact.

LOC analysis is an important and rapidly expanding area of diagnostic technology. These devices seek to replace standard clinical diagnostic tools with miniaturized platforms that facilitate low-volume detection methods. The use of such technologies is particularly attractive as it pertains to public health care in the developing world, as these miniaturized tools hold the potential for sensitive, low-cost, POC diagnosis. While many advances have been made in the field, it remains largely unproven, especially in POC applications.

Metallic dendrites are an important class of nanostructures for LOC development. They consist of branching, tree-like projections of crystals of a single metal or alloy. Directed electrochemical nanowire assembly (DENA) is a one-step, high growth rate technique to produce oriented, single-crystal metallic dendrites from an electrode surface. An alternating electric field in the presence of a salt solution induces the crystallization of dendrites onto an electrode, while the direction and orientation of growth is determined by the electric field and electrode configuration. DENA was first performed for the growth of palladium nanowires, but has since been used for the fabrication of structures composed of various metallic crystals, such as platinum, gold and silver.

Dendrites are an attractive substrate for biosensing applications, in part, due to an increase in the effective surface area that affords higher detection sensitivity. This is accomplished by tethering a greater number of the biomolecules used as recognition elements for specific antigens on the electrode surface compared to a planar substrate of the same footprint area. Indeed, metallic dendrites are being used more frequently in the realm of biosensing, including catalysis, chemical sensing, and electrochemical sensing.

On this latter point, positioning of both capture and detection reagents on the surface of an electrode has resulted in a highly sensitive diagnostic device for human immunodeficiency virus. A miniaturized sensing device based on a dendritic architecture may be capable of highly sensitive biomolecule detection due to the increased number of recognition elements as well as the localization of those elements. The ability to achieve high sensitivity on a miniaturized electrode also means that a metallic dendrite-based sensor would require a smaller quantity of sensing reagents, decreasing the cost per test and furthering the goal of LOC detection.

Use of intrinsically conductive polypyrroles is also popular and widespread in biosensing applications, and extensively reviewed. The ease and gentle conditions of polymerization, and the electroconductive stability of the film, makes polypyrrole an attractive tool for LOC device fabrication. As a result, pyrrole and its derivatives have been used in biosensors ranging from neural probes, glucose sensing devices and DNA biosensors. N-substituted polypyrroles with terminal cyano groups have been utilized to construct immunosensors via electrostatic and electrochemically-directed tethering of antibodies to the surface of gold electrodes. In both cases, interactions between antibody OH groups and the terminal CN group of the polymer film were used to tether the antibody to the electrode surface. This afforded a higher level of control over the antibody orientation than would be possible on a bare gold substrate. This is important in order to preserve the availability of the antigen-sensing region for analyte recognition. A greater number of correctly oriented antibodies could result in a more sensitive device.

Despite advances in biosensor research, there is still a scarcity of biosensors for detection of analytes, e.g., analytes associated with a clinical condition such as a subject having an infectious disease, that easily manufactured at scale and low cost suitable for use in a point-of-care clinical context, particularly in resource limited environments. These needs and other needs are satisfied by the present disclosure.

### SUMMARY

The present disclosure pertains to biosensors comprising a WE layer comprising a dendritic array comprising metallic dendrites having a conductive polymer coating. In some aspects, the dendritic structures are pillared. In a further aspect, the dendritic structures are essentially free of planar dendritic structures. Use of the disclosed biosensors provides improved detection sensitivity in the disclosed methods, i.e., the disclosed biosensors can exceed the sensitivity of a simple planar electrode and is capable of matching the diagnostic sensitivity of a standard optical ELISA. The disclosed biosensing platform represents an avenue for POC disease diagnosis, including, but not limited to, resource limited areas. In various aspects, the present disclosure further provides for a fully integrated on-chip diagnostic device comprising a microfluidic chip housing, as well as software to interpret electrochemical results for the end user. In a specific instance, the disclosed biosensors can be utilized in method of the detection of CTX.

In a further aspect, the present disclosure pertains to methods of making the disclosed biosensors provide for improved control of dendritic growth using a pillared gold substrate, rather than a planar one. In a still further aspect, the disclosed methods are able to provide dendrites that preferentially grow out from a sharp pillar tip.

In a further aspect, the present disclosure pertains to method of using the disclosed biosensors with one or more antibodies to detect a target analyte. Although disclosed herein in the examples are use of the disclosed sensors for detection of cholera toxin subunit B, applications of the disclosed methods of detecting an analyte are not limited to cholera detection. For example, other analytes associated with a particular disease, e.g., a disease-related biomarker for which there are effective antibodies commercially available, can be detected using the disclosed biosensors

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1B show a representative schematic overview of the dendrite-based on-chip ELISA. FIG. 1A show the sequence of dendrites grown on a planar gold substrate to dendrites coated in a film of poly(2-cyanoethyl)pyrrole (PCEPy) to a primary antibody to cholera toxin (CTX), tethered to PCEPy-coated dendrites via electrostatic interactions. In the disclosed method, a secondary anti-CTX antibody and tertiary antibody are added, with with wash steps after the addition of each of the secondary anti-CTX antibody and the tertiary antibody. FIG. 1B shows a schematic representation of alkaline phosphatase (ALP) conjugated to a tertiary antibody capable of reacting with the substrate p-aminophenyl phosphate (pAPP) to form 4-aminophenol (4-AP), which can oxidizes at −100 mV versus a pseudo Ag/AgCl reference electrode as shown in the graph. The redox peak is proportional to the amount of CTX in the sample.

FIGS. 2A-2D show a representative schematic overview of fabrication and representative images of characterization of dendritic structures. FIG. 2A a schematic view of an experimental setup for dendritic growth via DENA where a planar gold substrate acts as a WE (right) with a parallel Pt CE (left). In the schematic drawing, dendrite growth is visible as a rust-like area on portions of the WE that are submerged in the HAuCl4. FIGS. 2B and 2C show representative scanning electron micrographs obtained at 300× magnification before (FIG. 2C) and after DENA (FIG. 2B) demonstrate a change in surface architecture. The scale bars in FIGS. 2B and 2C represent 100 μm. The planar chip before DENA was imaged on an edge to aid in visualization, as the surface lacks any appreciable features otherwise. Defects on the planar chip are a result of the dicing process. FIG. 2D shows a representative scanning electron micrograph obtained at a magnification of 30,000×. The image shows the roughness of the dendrite surface as a result of the DENA process. The scale bar represents 500 nm.

FIGS. 3A-3C show representative DPV signal data obtained from representative CTX dose titrations on gold electrodes. FIG. 3A shows representative data for CTX concentrations ranging from 0.5 to 500 ng mL−1 examined on a planar gold electrode. FIG. 3B shows representative data for CTX concentrations ranging from 0.5 to 500 ng mL−1 examined on a dendritic gold electrode. FIG. 3C shows representative data for low concentrations that are shown isolated in order to better illustrate the 4-AP redox peak at 1 ng mL−1. All DPV data were baselined at −200 mV to elucidate the true peak current. Note that deviations in peak redox potential from −100 mV were likely due to the use of a pseudoreference electrode, which may have caused some minor voltage drift. X axis represents potential; Y axis represents current.

FIGS. 4A-4B show representative data pertaining to determination of relative surface area of dendrite chips vs planar. FIG. 4A shows representative data for overlaid CVs of 500 mM sulfuric acid on each nanostructure. The data show that the dendrite array has a significantly higher surface area relative to the planar electrode. The X axis represents DC bias potential; and the Y axis represents current. FIG. 4B shows representative data for the average relative surface area of three of the dendrite chips was calculated by normalizing relative to results from three planar electrodes. Error bars represent the standard deviation.

FIGS. 4A-4B show representative data for electrochemical ELISA readouts on planar and dendritic electrodes. Electrochemical performance was compared as a function of both peak current (Iₚ) vs. CTX concentration (FIG. 4A) and of current density vs. CTX concentration (FIG. 4B), in order to control for differences in the size of the base area of each chip. All data points represent 3 trials, and error bars represent the standard deviation.

FIGS. 5A-5B show representative electrochemical ELISA readouts on planar and dendritic electrodes. FIG. 5A shows electrochemical performance data compared as a function of peak current (Ip) vs. CTX concentration. FIG. 5B shows electrochemical performance data compared as a function of current density vs. CTX concentration. All data points represent 3 trials, and error bars represent the standard deviation.

FIG. 6 shows data for a log-linear (inset: log-log) comparison of ELISA techniques. Measurements of each concentration of CTX were taken in triplicate for each ELISA setup: planar electronic (square), dendrite electronic (circle), and optical (triangle). To compare electronic ELISA performance, peak current density was determined by dividing peak current by the footprint area of each device and plotted against CTX concentration. Electronic data were also normalized to optical data in order to further compare detection performance against the optical ELISA. Error bars represent the standard deviation of three ELISAs performed on each platform. X axis is CTX concentration; Y axis is peak current density (dendrites, planar) or absorbance at λ=600 nm (optical).

FIGS. 7A-7C show representative images of chip setup and PCEPy characterization. FIG. 7A shows representative chips contained in a 7 well housing and connected to a potentiostat. An external CE and RE can be inserted into the well of interest for electrochemical measurements. FIG. 7B shows a representative dendrite chip following PCEPy deposition. Areas corresponding to the 7 wells on the chip housing appear as darkened spots relative to the dendrite surface around them, providing visual confirmation of PCEPy deposition (example marked with a white circle). FIG. 7C representative data for electrochemical confirmation of PCEPy deposition obtained by DPV of a monomer-free solution of NaClO4. A peak at ˜400 mV was indicative of the presence of PCEPy.

FIG. 8 shows a cross-sectional side view of schematic representation of a disclosed biosensor.

FIG. 9 shows a cross-sectional side view of schematic representation of a disclosed biosensor.

FIG. 10 shows a cross-sectional side view of schematic representation of a portion of a disclosed biosensor comprising a substrate layer, an adhesion layer, a WE layer, and dendritic layer showing details of a disclosed dendritic structure comprising a metal dendrite comprising a dendritic coating.

FIGS. 11A-11C show cross-sectional side views of schematic representations of a portion of a disclosed biosensor comprising a substrate layer at different steps of a disclosed method of detecting an analyte. FIG. 11A shows a representative biosensor component detail portion showing the detail portion at a step of a disclosed method of detecting an analyte wherein a primary analyte antibody 1010 is in contact with dendritic layer 400. FIG. 11B shows a representative biosensor component detail portion showing the biosensor component detail portion at a step of a disclosed method of detecting an analyte wherein a primary analyte antibody 1010 is in contact with dendritic layer 400 and the analyte 1100. FIG. 11C shows a representative biosensor component detail portion showing the biosensor component detail portion at a step of a disclosed method of detecting an analyte wherein a primary analyte antibody 1010 is in contact with dendritic layer 400 and an analyte 1100, wherein a secondary analyte antibody 1020 is in contact with the analyte 1100, and wherein a tertiary detection antibody 1030, comprising a tertiary antibody 1031 conjugated to a detection enzyme 1032, is in contact with the secondary analyte antibody 1020.

FIGS. 12A-12D show representative perspective diagram views showing appearance of disclosed biosensor layers during various fabrication steps to a prepare a biosensor component having a substrate layer 100, an adhesion layer 200, a WE layer 300, and a dendritic layer 400. FIG. 12A shows a representative perspective diagram view of a substrate layer. FIG. 12B shows a representative perspective diagram view of a substrate layer with adhesion layer thereon. FIG. 12C shows a representative perspective diagram view of a substrate layer with adhesion layer and WE layer thereon. FIG. 12D shows a representative perspective diagram view of a substrate layer with adhesion layer, WE layer, and dendritic layer thereon.

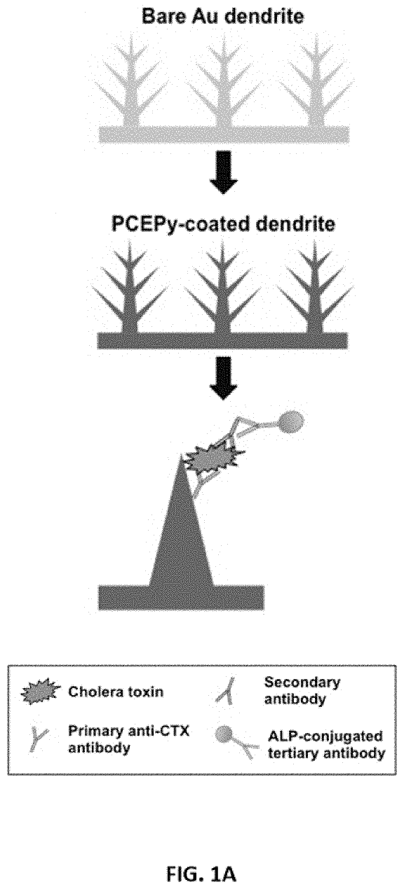

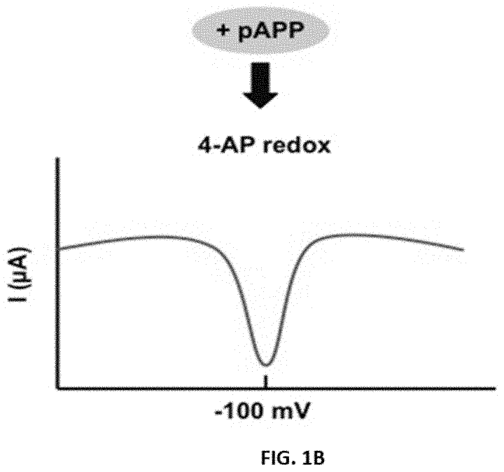

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Many modifications and other aspects disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present disclosure is not entitled to antedate such publication by virtue of prior disclosure. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### A. DEFINITIONS

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used herein, the term “and/or” includes any and all combinations of one or more of the associated listed items. Expressions such as “at least one of,” when preceding a list of elements, modify the entire list of elements and do not modify the individual elements of the list.

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

As used in the specification and the appended claims, the singular forms “a,” “an” and “the” include plural referents unless the context clearly dictates otherwise. Thus, for example, reference to “a dendrite,” “an antibody,” or “a biosensor,” includes, but is not limited to, two or more such dendrites, antibodies, biosensors, and the like, including a plurality of such dendrites, antibodies, biosensors, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of an antibody refers to an amount that is sufficient to achieve the desired improvement or effect modulated by indicated component, material, compound or protein, e.g. achieving the desired level of binding with an analyte bound by the antibody. The specific level in terms of concentration or amount as an effective amount will depend upon a variety of factors avidity of the antibody, target analyte, desired level of assay sensitivity and the like.

The term “contacting” as used herein refers to bringing a disclosed analyte, compound, chemical, or material in proximity to another disclosed analyte, compound, chemical, or material as indicated by the context. For example, an analyte contacting an antibody refers to the analyte being in proximity to the antibody by the analyte interacting and binding to the antibody via ionic, dipolar and/or van der Waals interactions. In some instances, contacting can comprise both physical and chemical interactions between the indicated components. It is to be understood that chemical interactions can comprise a combination of covalent and non-covalent interactions, including one or more of ionic, dipolar, van der Waals interactions, and the like. For example, a WE layer contacting a substrate layer is understood to mean that the WE layer is in physical and chemical contact with the substrate layer that can comprise covalent, ionic, and non-covalent interactions.

As used herein, “analyte” refers to any molecule, compound, or particle capable of being detected, i.e., bound by each of a primary analyte antibody and a secondary analyte antibody.

The term “antibody” as used herein refers to a polypeptide of the immunoglobulin family that is capable of binding a corresponding antigen non-covalently, reversibly, and in a specific manner. For example, a naturally occurring IgG antibody is a tetramer comprising at least two heavy (H) chains and two light (L) chains inter-connected by disulfide bonds. Each heavy chain is comprised of a heavy chain variable region (abbreviated herein as VH) and a heavy chain constant region. The heavy chain constant region is comprised of three domains, CH1, CH2 and CH3. Each light chain is comprised of a light chain variable region (abbreviated herein as VL) and a light chain constant region. The light chain constant region is comprised of one domain, CL. The VH and VL regions can be further subdivided into regions of hypervariability, termed complementarity determining regions (CDR), interspersed with regions that are more conserved, termed framework regions (FR). Each VH and VL is composed of three CDRs and four FRs arranged from amino-terminus to carboxy-terminus in the following order: FR1, CDR1, FR2, CDR2, FR3, CDR3, and FR4. The variable regions of the heavy and light chains contain a binding domain that interacts with an antigen. The constant regions of the antibodies may mediate the binding of the immunoglobulin to host tissues or factors, including various cells of the immune system (e.g., effector cells) and the first component (C1q) of the classical complement system.

The term “antibody” includes, but is not limited to, monoclonal antibodies, human antibodies, humanized antibodies, chimeric antibodies, and anti-idiotypic (anti-Id) antibodies (including, e.g., anti-Id antibodies to antibodies of the invention). The antibodies can be of any isotype/class (e.g., IgG, IgE, IgM, IgD, IgA and IgY), or subclass (e.g., IgG1, IgG2, IgG3, IgG4, IgA1 and IgA2).

“Complementarity-determining domains” or “complementary-determining regions (“CDRs”) interchangeably refer to the hypervariable regions of VL and VH. The CDRs are the target protein-binding site of the antibody chains that harbors specificity for such target protein. There are three CDRs (CDR1-3, numbered sequentially from the N-terminus) in each human VL or VH, constituting about 15-20% of the variable domains. The CDRs are structurally complementary to the epitope of the target protein and are thus directly responsible for the binding specificity. The remaining stretches of the VL or VH, the so-called framework regions, exhibit less variation in amino acid sequence (Kuby, Immunology, 4th ed., Chapter 4. W.H. Freeman & Co., New York, 2000).

The positions of the CDRs and framework regions can be determined using various well known definitions in the art, e.g., Kabat, Chothia, international ImMunoGeneTics database (IMGT) (on the worldwide web at imgt.cines.fr/), and AbM (see, e.g., Johnson et al., Nucleic Acids Res., 29:205-206 (2001); Chothia and Lesk, J. Mol. Biol., 196:901-917 (1987); Chothia et al., Nature, 342:877-883 (1989); Chothia et al., J. Mol. Biol., 227:799-817 (1992); Al-Lazikani et al., J. Mol. Biol., 273:927-748 (1997)). Definitions of antigen combining sites are also described in the following: Ruiz et al., Nucleic Acids Res., 28:219-221 (2000); and Lefranc, M. P., Nucleic Acids Res., 29:207-209 (2001); MacCallum et al., J. Mol. Biol., 262:732-745 (1996); and Martin et al., Proc. Natl. Acad. Sci. USA, 86:9268-9272 (1989); Martin et al., Methods Enzymol., 203:121-153 (1991); and Rees et al., In Sternberg M. J. E. (ed.), Protein Structure Prediction, Oxford University Press, Oxford, 141-172 (1996).

Both the light and heavy chains are divided into regions of structural and functional homology. The terms “constant” and “variable” are used functionally. In this regard, it will be appreciated that the variable domains of both the light (VL) and heavy (VH) chain portions determine antigen recognition and specificity. Conversely, the constant domains of the light chain (CL) and the heavy chain (CH1, CH2 or CH3) confer important biological properties such as secretion, transplacental mobility, Fc receptor binding, complement binding, and the like. By convention, the numbering of the constant region domains increases as they become more distal from the antigen binding site or amino-terminus of the antibody. The N-terminus is a variable region and at the C-terminus is a constant region; the CH3 and CL domains actually comprise the carboxy-terminal domains of the heavy and light chain, respectively.

The term “antigen binding fragment”, as used herein, refers to one or more portions of an antibody that retain the ability to specifically interact with (e.g., by binding, steric hindrance, stabilizing/destabilizing, spatial distribution) an epitope of an antigen. Examples of binding fragments include, but are not limited to, single-chain Fvs (scFv), camelid antibodies, disulfide-linked Fvs (sdFv), Fab fragments, F(ab′) fragments, a monovalent fragment consisting of the VL, VH, CL and CH1 domains; a F(ab)2 fragment, a bivalent fragment comprising two Fab fragments linked by a disulfide bridge at the hinge region; a Fd fragment consisting of the VH and CH1 domains; a Fv fragment consisting of the VL and VH domains of a single arm of an antibody; a dAb fragment (Ward et al., Nature 341:544-546, 1989), which consists of a VH domain; and an isolated complementarity determining region (CDR), or other epitope-binding fragments of an antibody.

Furthermore, although the two domains of the Fv fragment, VL and VH, are coded for by separate genes, they can be joined, using recombinant methods, by a synthetic linker that enables them to be made as a single protein chain in which the VL and VH regions pair to form monovalent molecules (known as single chain Fv (“scFv”); see, e.g., Bird et al., Science 242:423-426, 1988; and Huston et al., Proc. Natl. Acad. Sci. 85:5879-5883, 1988). Such single chain antibodies are also intended to be encompassed within the term “antigen binding fragment.” These antigen binding fragments are obtained using conventional techniques known to those of skill in the art, and the fragments are screened for utility in the same manner as are intact antibodies.

Antigen binding fragments can also be incorporated into single domain antibodies, maxibodies, minibodies, nanobodies, intrabodies, diabodies, triabodies, tetrabodies, v-NAR and bis-scFv (see, e.g., Hollinger and Hudson, Nature Biotechnology 23:1126-1136, 2005). Antigen binding fragments can be grafted into scaffolds based on polypeptides such as fibronectin type III (Fn3) (see U.S. Pat. No. 6,703,199, which describes fibronectin polypeptide monobodies).

Antigen binding fragments can be incorporated into single chain molecules comprising a pair of tandem Fv segments (VH-CH1-VH-CH1) which, together with complementary light chain polypeptides, form a pair of antigen binding regions (Zapata et al., Protein Eng. 8:1057-1062, 1995; and U.S. Pat. No. 5,641,870).

The term “monoclonal antibody” or “monoclonal antibody composition” as used herein refers to polypeptides, including antibodies and antigen binding fragments that have substantially identical amino acid sequence or are derived from the same genetic source. This term also includes preparations of antibody molecules of single molecular composition. A monoclonal antibody composition displays a single binding specificity and affinity for a particular epitope.

The term “recognize” as used herein refers to an antibody or antigen binding fragment thereof that finds and interacts (e.g., binds) with its epitope, whether that epitope is linear or conformational. The term “epitope” refers to a site on an antigen to which an antibody or antigen binding fragment of the invention specifically binds. Epitopes can be formed both from contiguous amino acids or noncontiguous amino acids juxtaposed by tertiary folding of a protein. Epitopes formed from contiguous amino acids are typically retained on exposure to denaturing solvents, whereas epitopes formed by tertiary folding are typically lost on treatment with denaturing solvents. An epitope typically includes at least 3, 4, 5, 6, 7, 8, 9, 10, 11, 12, 13, 14 or 15 amino acids in a unique spatial conformation. Methods of determining spatial conformation of epitopes include techniques in the art, for example, x-ray crystallography and 2-dimensional nuclear magnetic resonance (see, e.g., Epitope Mapping Protocols in Methods in Molecular Biology, Vol. 66, G. E. Morris, Ed. (1996)).

The term “affinity” as used herein refers to the strength of interaction between antibody and antigen at single antigenic sites. Within each antigenic site, the variable region of the antibody “arm” interacts through weak non-covalent forces with antigen at numerous sites; the more interactions, the stronger the affinity.

The phrase “specifically binds” or “selectively binds,” when used in the context of describing the interaction between an antigen (e.g., a protein) and an antibody, antibody fragment, or antibody-derived binding agent, refers to a binding reaction that is determinative of the presence of the antigen in a heterogeneous population of proteins and other biologics, e.g., in a biological sample, e.g., a blood, serum, plasma or tissue sample. Thus, under certain designated immunoassay conditions, the antibodies or binding agents with a particular binding specificity bind to a particular antigen at least two times the background and do not substantially bind in a significant amount to other antigens present in the sample. In one embodiment, under designated immunoassay conditions, the antibody or binding agent with a particular binding specificity binds to a particular antigen at least ten (10) times the background and does not substantially bind in a significant amount to other antigens present in the sample. Specific binding to an antibody or binding agent under such conditions may require the antibody or agent to have been selected for its specificity for a particular protein. As desired or appropriate, this selection may be achieved by subtracting out antibodies that cross-react with molecules from other species (e.g., mouse or rat) or other subtypes. Alternatively, in some embodiments, antibodies or antibody fragments are selected that cross-react with certain desired molecules.

Reference to “a/an” chemical compound, protein, and antibody each refers to one or more molecules of the chemical compound, protein, and antibody rather than being limited to a single molecule of the chemical compound, protein, and antibody. Furthermore, the one or more molecules may or may not be identical, so long as they fall under the category of the chemical compound, protein, and antibody. Thus, for example, “an” antibody is interpreted to include one or more antibody molecules of the antibody, where the antibody molecules may or may not be identical (e.g., different isotypes and/or different antigen binding sites as may be found in a polyclonal antibody).

Certain materials, compounds, compositions, and components disclosed herein can be obtained commercially or readily synthesized using techniques generally known to those of skill in the art. For example, the starting materials and reagents used in preparing the disclosed compounds and compositions are either available from commercial suppliers such as Aldrich Chemical Co., (Milwaukee, Wis.), Acros Organics (Morris Plains, N.J.), Fisher Scientific (Pittsburgh, Pa.), or Sigma (St. Louis, Mo.) or are prepared by methods known to those skilled in the art following procedures set forth in references such as those referred to herein below.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

As used herein, the terms “optional” or “optionally” means that the subsequently described event or circumstance can or cannot occur, and that the description includes instances where said event or circumstance occurs and instances where it does not.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

Unless otherwise specified, temperatures referred to herein are based on atmospheric pressure (i.e. one atmosphere).

The following abbreviations are used herein throughout:
4-AP=4-aminophenol
CE=counter electrode
CTX=cholera toxin subunit B
DENA=directed electrochemical nanowire assembly
DPV=differential pulse voltammetry
PCEPy=poly(2-cyanoethyl)pyrrole
pAPP=p-aminophenyl phosphate
POC=point-of-care
RE=reference electrode
SEM=scanning electron microscopy
WE=working electrode

As noted above, like reference numerals designate corresponding parts throughout the several views. The following reference numbers are used herein throughout:
10: Biosensor component.
20: Biosensor component detail portion showing substrate layer 100, adhesion layer 200, a WE layer 300, and dendritic layer 400.
30: Biosensor component detail portion showing the biosensor component detail portion at a step of a disclosed method of detecting an analyte wherein a primary analyte antibody 1010 is in contact with dendritic layer 400.
31: Biosensor component detail portion showing the biosensor component detail portion at a step of a disclosed method of detecting an analyte wherein a primary analyte antibody 1010 is in contact with dendritic layer 400 and the analyte 1100.
32: Biosensor component detail portion showing the biosensor component detail portion at a step of a disclosed method of detecting an analyte wherein a primary analyte antibody 1010 is in contact with dendritic layer 400 and an analyte 1100, wherein a secondary analyte antibody 1020 is in contact with the analyte 1100, and wherein a tertiary detection antibody 1030, comprising a tertiary antibody 1031 conjugated to a detection enzyme 1032, is in contact with the secondary analyte antibody 1020.
100: Substrate layer.
200: Adhesion layer.
210: Combination Substrate/Adhesion layer.
300: WE layer.
400: Dendritic layer comprising a conductive polymer layer 700 comprising a dendrite conductive polymer layer 701, which is in contact with metallic pillared dendrite, and a WE conductive polymer layer 702, which is in contact with WE layer, in which the dendrite conductive polymer layer 701 is on or covers metallic pillared dendrites 800.
510: WE connect.
520: RE.
530: CE.
600: Sample chamber comprising sampling solution.
700: Conductive polymer layer comprising a dendrite conductive polymer layer 701, which is in contact with metallic pillared dendrite, and a WE conductive polymer layer 702, which is in contact with WE layer.
701: Dendrite conductive polymer layer 701, which is in contact with metallic pillared dendrite.
702: WE conductive polymer layer 702, which is in contact with WE layer.
800: Metallic pillared dendrite which are in contact with the WE layer 300.
1010: Primary analyte antibody.
1020: Secondary analyte antibody.
1030: Tertiary detection antibody comprising a tertiary antibody 1031 conjugated to a detection enzyme 1032.
1031: Tertiary antibody 1031 that is conjugated to a detection enzyme 1032.
1032: Detection enzyme 1032 that is conjugated to a tertiary antibody 1031.
1100: Analyte.

### B. BIOSENSORS

The present disclosure describes a biosensing platform comprising biosensors comprising a WE layer comprising a dendritic array comprising metallic dendrites having a conductive polymer coating. In some aspects, the dendritic structures are pillared. In a further aspect, the dendritic structures are essentially free of planar dendritic structures. Use of the disclosed biosensors provides improved detection sensitivity in the disclosed methods, i.e., the disclosed biosensors can exceed the sensitivity of a simple planar electrode and is capable of matching the diagnostic sensitivity of a standard optical ELISA. In various aspects, the disclosed biosensors can be used in methods for detecting an analyte, the method comprising an electrochemical ELISA method. The disclosed biosensing platform represents an avenue for POC disease diagnosis, including, but not limited to, resource limited areas. In various aspects, the present disclosure further provides for a fully integrated on-chip diagnostic device comprising a microfluidic chip housing, as well as software to interpret electrochemical results for the end user.

Electrochemical performance of these dendritic sensors was evaluated against a planar gold sensor and a standard optical ELISA to determine its potential for development as a POC diagnostic device. The present disclosure found that the dendritic chip outperformed the planar control in terms of sensitivity, and had a comparable limit of detection to an optical ELISA. As the device of the present disclosure can potentially be deployed with minute amounts of reagent (in the nL range) this performance makes it a candidate for further development towards a fully integrated LOC device for the detection of cholera toxin and potentially other antigens.

The current disclosure demonstrates features and advantages that will become apparent to one of ordinary skill in the art upon reading the attached Detailed Description. Rapid diagnosis of infectious disease at the site of the patient is critical for preventing the escalation of an outbreak into an epidemic. Devices suited to point-of-care (POC) diagnosis of cholera must not only demonstrate clinical laboratory levels of sensitivity and specificity, but it must do so in a portable and low-cost manner, with a simplistic readout. The present disclosure describes a lab-on-a-chip (LOC) electrochemical immunosensor for the detection of cholera toxin subunit B (CTX), based on a dendritic gold architecture functionalized with poly-(2-cyano-ethyl)pyrrole (PCEPy). The dendritic electrode has an ˜18× greater surface area than a planar gold counterpart, per electrochemical measurements, allowing for a higher level of diagnostic sensitivity. PCEPy polymer allowed an electrochemical enzyme-linked immunosorbant assay (ELISA) for CTX to be performed directly on the dendritic sensor, which demonstrated a limit-of-detection of 1 ng mL−1, per a signal-to-noise ratio of 2.6, which was more sensitive than a simple planar gold electrode (100 ng mL−1). This sensitivity also matches a currently available diagnostic standard, the optical ELISA, and does so on a miniaturized platform with electrical readout. The ability to meet POC demands makes biofunctionalized gold dendrites a promising architecture for a LOC biosensor for the detection of cholera.

The disclosed biosensors provide an electrochemical cell for use in the disclosed methods. As described herein, the biosensors comprise a working electrode layer, a counter electrode (also referred to as an auxiliary electrode) and a reference electrode. The foregoing electrodes can be immersed in the same electrolyte solution or in different electrolyte solutions. For example, the working and counter electrodes are in electrical contact with the reference electrode either by immersing the electrodes in the same electrolyte solution or by immersing the working and counter electrodes in an electrolyte solution which is electrically linked to the reference electrode electrolyte by a salt-bridge or a semi-peri teable membrane.

The reference electrode can be any commonly used reference electrode such as for example a hydrogen electrode, a calomel electrode or copper/copper(II) sulfate electrode. In a preferred aspect the reference electrode is a silver/silver chloride electrode. The counter electrode can be any commonly used counter electrodes such as for example platinum electrode or a stainless steel electrode.

The electrochemical cell may also be constructed comprising only a working and a counter electrode immersed in the same electrolyte solution or in different electrolyte solutions separated by a semipermeable membrane. The reference electrode can function as a cathode whenever the working electrode is operating; as an anode and vice versa. The potential of the reference electrode is usually not measured and is adjusted so as to balance the reaction occurring at the working electrode, reference electrodes are often fabricated from electrochemically inert materials such as gold, platinum, or carbon.

The electrolyte solution comprises charge carriers that are ions or molecules. The charge carriers may be selected from the group consisting of protons, hydroxide ions, metal ions, halide ions, ammonium ions and oxyanions. Oxyanions may include nitrate ions, sulphate ions and phosphate ions. In a preferred aspect the electrolyte solution is a salt water solution. For example, the electrolyte may comprise NaCl.

The electrolyte solution may further comprise a pH buffer such as for example HEPES, PBS or Tris. Preferably, the electrolyte solution has a pH at which the enzymes adsorbed at the electrode of the disclosure are stable and active. Preferably the electrolyte solution is maintained at a pH of between 5 and 10 and more preferably between 7 and 8.

In the electrochemical cell as described herein the current flowing with the working electrode at a given potential relative to the reference electrode, may be used as a quantitative measure of the amount of oxidized or reduced redox agent present in the electrolyte. The current flowing in the electrochemical cell can be related to the concentration of the oxidized or reduced form of the redox agent present in the electrolyte through equations which are well known in the art.

The electrochemical cell can for example function as a voltammetric transducer where cell current is recorded as a function of the applied potential thereby generating a voltammogram. The current flowing in the electrochemical cell can be related to the concentration of the oxidized or reduced form of the redox agent present in the electrolyte through equations which are well known in the art. The electrochemical cell may for example employ cyclic voltammetry, differential pulse voltammetry, square wave voltammetry, impedance spectroscopy, chronoamperometry, or chronocoulometry.

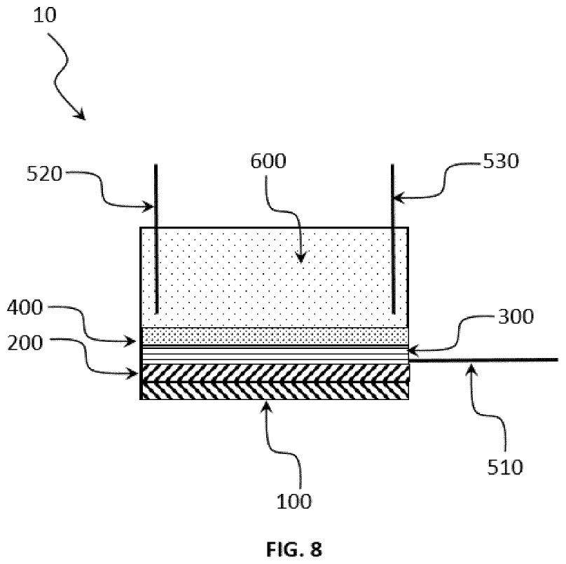

Referring now to FIG. 8, which shows a cross-sectional side view of schematic representation of a disclosed biosensor 10. The biosensor 10 comprises a substrate layer 100, adhesion layer 200, a WE layer 300, a dendritic layer 400, a sample chamber 600, show comprising a sampling solution, and a trielectrode system comprising a WE connect 510 to the WE layer 300, a RE 520, and a CE 530.

The substrate layer 100 comprises a material such as a silicon substrate, e.g., a silicon substrate such as a silicon wafer or other silicon substrate comprising silicon or silicon oxide, a glass substrate, or a carbon substrate. A silicon substrate can be a monocrystalline silicon substrate or a polycrystalline silicon substrate. A glass substrate can comprise one or more of: soda-lime glass, of which the main ingredients are silicon dioxide, sodium oxide, and calcium oxide; aluminosilicate glass, of which the main ingredients are silicon dioxide, aluminum oxide, and R2O (where R═K, Na, Li); borosilicate glass; lithium oxide-silicon dioxide glass; lithium oxide-aluminum oxide-silicon dioxide glass; R′O-aluminum oxide-silicon dioxide glass (where R′═Mg, Ca, Sr, Ba). Any of these glass materials may have zirconium oxide, titanium oxide, or the like added thereto. In some aspects, a carbon substrate can be an amorphous carbon substrate including, for example, amorphous carbon substrates prepared by carbonizing or pyrolyzing molded thermosetting resins, optionally containing carbon fillers such as graphite, carbon black, etc. Such carbon substrates may be formed by cast molding, compression molding, injection molding or any other known molding method. In a further aspect, a carbon substrate can be a carbon paper.

In some aspects, the substrate layer 100 is electrically non-conductive. In various aspects, the substrate layer 100 is has a thickness of from about 20 μm to about 10 mm. In a further aspect, the substrate layer 100 has a thickness of from bout 100 μm to about 1 mm. In a still further aspect, the substrate layer 100 has a thickness of from about 200 μm to about 500 μm.

The adhesion layer 200 comprises a material capable of supporting the WE layer 300 and connecting the WE layer 300 to the substrate layer 100. Moreover, the adhesion layer 200 should be capable of adhering to each of the WE layer 300 and the substrate layer 100 via chemical and/or physical interactions. For example, in various aspects, the adhesion layer 200 can comprise tungsten, titanium, chromium, nickel, and combinations thereof. In a further aspect, the adhesion layer 200 comprises at least tungsten. In a still further aspect, the adhesion layer 200 comprises tungsten. In an aspect, the thickness of the adhesion layer 200 can be from about 1 nm to about 1 μm. In a further aspect, the thickness of the adhesion layer 200 can be from about 2 nm to about 100 nm. In a still further aspect, the thickness of the adhesion layer 200 can be from about 5 nm to about 20 nm.

The WE layer 300 comprises a material capable of supporting growth of dendritic structures using the methods described herein. In various aspects, the WE layer 300 can comprise gold, silver, palladium, platinum, copper, titanium, or combinations thereof. In a further aspect, the WE layer 300 can comprise gold, silver, palladium, platinum, copper, or combinations thereof. In a still further aspect, the WE layer 300 comprises at least gold. In a still further aspect, the WE layer 300 comprises gold. In an aspect, the thickness of the WE layer 300 can be from about 10 nm to about 10 μm. In a further aspect, the thickness of the WE layer 300 can be from about 20 nm to about 1 μm. In a still further aspect, the thickness of the WE layer 300 can be from about 50 nm to about 200 nm.

The dendrite layer 400 comprises a conductive polymer layer 700 comprising a dendrite conductive polymer layer 701, which is in contact with metallic pillared dendrite, and a WE conductive polymer layer 702, which is in contact with WE layer, in which the dendrite conductive polymer layer 701 is on or covers metallic pillared dendrites 800. In various aspects, the metallic pillared dendrites 800 can comprise the same material as in the WE layer 300 on which they are formed, that is, the metallic pillared dendrites 800 can comprise gold, silver, palladium, platinum, copper, titanium, or combinations thereof, provided that is is the same material as the WE layer 300. In a further aspect, the metallic pillared dendrites 800 can comprise gold, silver, palladium, platinum, copper, or combinations thereof, provided that is is the same material as the WE layer 300. In a still further aspect, the metallic pillared dendrites 800 comprises at least gold, provided the WE layer 300 comprises at least gold. In a yet further aspect, the metallic pillared dendrites 800 comprises gold, provided the WE layer 300 comprises gold. In various aspects, the aggregate thickness of the WE layer 300 and the dendrite layer 400 can be from about 100 nm to about 1 mm. In a further aspect, the aggregate thickness of the WE layer 300 and the dendrite layer 400 can be from about 1 μm to about 100 μm. In a still further aspect, the aggregate thickness of the WE layer 300 and the dendrite layer 400 can be from about 10 μm to about 100 μm. In various aspects, the dendrite layer 400 further comprise a primary analyte antibody 1010.

The conductive polymer layer 700 comprising a dendrite conductive polymer layer 701, which is in contact with metallic pillared dendrite, and a WE conductive polymer layer 702, which is in contact with WE layer, is a suitable conductive polymer which is capable of contacting, e.g., tethering or binding, a desired primary analyte antibody 1010. In various aspects, the conductive polymer can comprise polypyrrole, polythiophene, polyaniline, polyacetylene, polyethylene vinylidene, polyfluorene, polycarbazole, polyvinyl phenol, polyphenylene, polypyridine, derivatives and copolymers thereof, and combinations thereof. In a further aspect, aspects, the conductive polymer can comprise polypyrrole, polythiophene, polyaniline, derivatives and copolymers thereof, and combinations thereof. In a still further aspect, the conductive polymer can comprise one or more polypyrrole. In a yet further aspect, the polypyrrole can comprise poly(2-cyanoethyl)pyrrole. In an even further aspect, the conductive polymer can comprise polythiophene. In a still further aspect, the polythiophene can comprise poly-3,4-ethylenedioxythiophene.

In various aspects, the dendrite layer 400 has an increase in surface area of about 5 times to about 50 times greater compared to a reference planar biosensor of essentially the same composition except for lacking a dendrite layer 400 and essentially the same footprint sensing area, e.g., the reference planar biosensor can be a biosensor comprising a substrate layer 100, adhesion layer 200, and a WE layer 300 of essentially the same footprint, as assessed via cyclic voltammetry. In a further aspect, the dendrite layer 400 has an increase in surface area of about 10 times to about 30 times greater compared to a reference planar biosensor. In a still further aspect, the dendrite layer 400 has an increase in surface area of about 10 times to about 20 times greater compared to a reference planar biosensor.

The RE electrode 520 can be a suitable reference electrode, e.g., a metal, which is at equilibrium with a poorly soluble metal salt such as a mercury/mercury sulfate electrode or silver/silver chloride electrode. In some instances the RE electrode 520 can comprise an internal electrolyte with a well-defined redox couple, a nonpolarizable electrode, and a porous frit to separate the sample electrolyte from the reference electrolyte. A small sensor cell can make use of a microreference electrode that can either be a custom built integrated planar RE or a commercially available one.

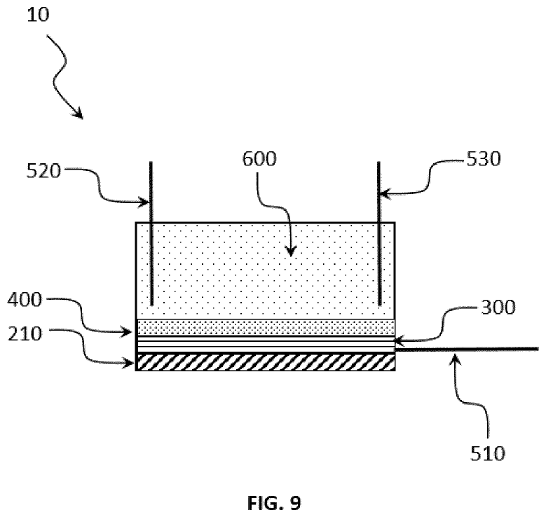

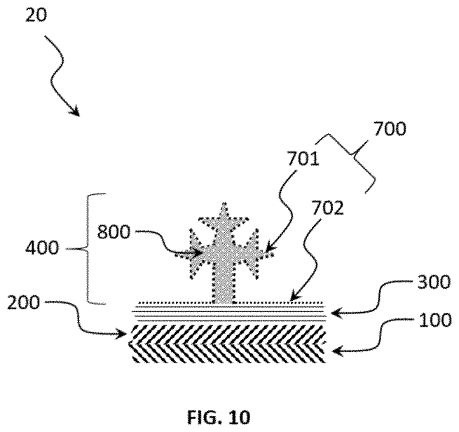

Referring now to FIG. 9, which shows a cross-sectional side view of schematic representation of a variant disclosed biosensor. The biosensor 10 comprises a combination substrate/adhesion layer 210, a WE layer 300, a dendritic layer 400, a sample chamber 600, show comprising a sampling solution, and a trielectrode system comprising a WE connect 510 to the WE layer 300, a RE 520, and a CE 530. The combination substrate/adhesion layer 210 can be a material that obviates the use of a substrate layer 100 and an adhesion layer 200 as described above. For example, suitable materials for the combination substrate/adhesion layer 210 can be a metal foil comprising aluminum, tungsten, titanium, chromium, nickel, gold, copper, silver, and combinations thereof. In a further aspect, the combination substrate/adhesion layer 210 can be a metal foil comprising at least tungsten. In a still further aspect, the combination substrate/adhesion layer 210 can be a metal foil comprising comprising tungsten.

In various aspects, the combination substrate/adhesion layer 210 can further comprise an optional adhesion layer thereon, i.e., disposed between the combination substrate/adhesion layer 210 and the adhesion layer 200. An optional adhesion layer on the combination substrate/adhesion layer 210 may be particularly useful if the metal foil is a material such as aluminum.

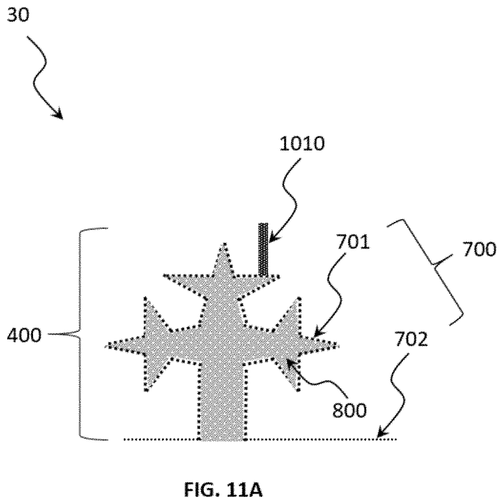

Referring now to FIG. 10, which shows a cross-sectional side view of schematic representation of a portion of a disclosed biosensor comprising a substrate layer 100, an adhesion layer 200, a WE layer 300, and a dendritic layer 400 comprising metallic pillared dendrite 800, which is in contact with the WE layer 300, and a conductive polymer layer 700 comprising a dendrite conductive polymer layer 701, which is in contact with metallic pillared dendrite, and a WE conductive polymer layer 702, which is in contact with WE layer. It is understood that the dendrite conductive polymer layer 701, which is in contact with metallic pillared dendrite, and the WE conductive polymer layer 702, which is in contact with WE layer, are continuous and in communication with each other.

The disclosed biosensors comprising the disclosed dendritic array affords several advantages over a full optical ELISA, which make it more amenable to POC use. Foremost, the optical ELISA, while sensitive and specific, lacks portability, requiring laboratory infrastructure and trained personnel. Given the often reduced access to healthcare facilities in resource-limited regions, the use of conventional optical ELISA is not suitable for deployment in such resource limited communities. By contrast, the small size and electrical readout of the dendritic sensor represents an important step toward portability and user-friendliness. Its low power needs (in the μW range) means that analysis can be performed using a smartphone. This allows for the creation of a user-friendly interface, which lessens the impact of human error in misdiagnoses. Portability is further bolstered by the commercial availability of miniaturized potentiostat modules. Taken together, a diagnostic tool based on a dendritic architecture could be a low-cost, portable, and easy-to-use alternative to the current diagnostic standard.

Compared with other detection platforms in the literature, dendrite-based or otherwise, the disclosed biosensors and methods of using the disclosed biosensors demonstrate competitive performance for detection of a target analyte. For example, infectious disease biomarkers such as CTX are detected with improved performance compared to conventional methods of detection of CTX (see Table 1 below which compares the disclosed biosensor detection method with conventional detection systems). In a particular aspect, the disclosed biosensors used in the disclosed methods of using the biosensors provides a method for diagnostic detection of cholera, which has a lethal dose of ˜100 ng mL⁻¹.

TABLE 1

| | | LLOQ | Recognition | Transduction |
|---|---|---|---|---|
| Reference | Analyte | (ng/mL)* | Element | Method |
| Disclosed | Cholera | 1 | antibody tethered | Voltammetry |
| device | toxin | | to gold surface | (DPV) |
| | | | with PCEPy | |
| Conventional | | | | |
| Dendrite- | | | | |
| based Devices | | | | |
| (8) | CA-125 | 0.1 | antibody SAM | Voltammetry |
| | | | (cystamine) | (DPV) |
| (10) | HIV-1, | 1 | antibody tethered | Voltammetry |
| | HIV-2 | | to SU8, proximal | (DPV) |
| | | | to gold surface | |
| Conventional | | | | |
| Cholera-spe- | | | | |
| cific Devices | | | | |
| (31) | Cholera | 1 | antibody tethered | Electro- |
| | toxin | | to gold surface | chemical |
| | | | with protein A | impedance |
| (32) | Cholera | 0.1 | antibody SAM | Capacitive |
| | toxin | | (EDC) | |
| (33) | Cholera | 0.00001 | GM1 and anti- | Colorimetric |
| | toxin | | body | |
| (34) | Cholera | 0.000001 | GM1 and anti- | Voltammetry |
| | toxin | | body (tethered | (SWV) |
| | | | by PEDOT) | |
| (35) | Cholera | 3000 | thiolated lactose | Colorimetric |
| | toxin | | derivative | |
| Conventional | | | | |
| Polypyrrole- | | | | |
| based Devices | | | | |
| (17) | Rabbit | 10 | antibody tethered | Electro- |
| | IgG | | to gold surface | chemical |
| | reagent | | with PCEPy | impedance |
| (18) | Bovine | 10 | antibody tethered | Quartz |
| | albumin | | to gold surface | crystal |
| | | | with PCEPy | microbalance |
| | | | (electrochemi- | |
| | | | cally oriented) | |

*“LLOQ” refers to the lowest concentration detected or lower limit of quantitation (in ng/mL)

While some of the conventional devices shown in Table 1 are associated with more sensitive detection limits than the disclosed devices, the disclosed devices overcome other drawbacks in their design which can limit deployment at POC, particularly in resource limited areas. For example, the conventional devices that achieved the most sensitive detection of cholera toxin were those that exploited the affinity of cholera toxin for the GM1 ganglioside. However, while GM1 is a natural receptor for both cholera toxin and Escherichia coli (E. coli) heat-labile enterotoxin, this strategy cannot be employed for the detection of other analytes. Conversely, the PCEPy-based platform of the present disclosure can make use of any commercially available antibody and thus detect a multitude of other biomarkers. Further, while many other devices can achieve impressive sensitivity on planar electrodes, the versatility of the disclosed dendrite fabrication makes this architecture more desirable. The one-step DENA process allows for easy modification of dendrite crystal morphology by altering parameters such as deposition time or voltage offset, in order to suit experimental needs. Finally, the disclosed PCEPy protocol described herein represents a significantly faster and simpler means of antibody tethering as compared to techniques used in the formation of antibody self-assembled monolayers (such as EDC-NHS coupling).

Overall, the present disclosure provides that the dendritic sensor preliminarily meets the POC diagnostic demands of low cost and portability, while still maintaining the sensitivity and specificity expected from a standard ELISA.

### C. METHODS OF MAKING THE DISCLOSED BIOSENSORS

In various aspects, the disclosed methods of making the disclosed biosensors provide for improved control of dendritic growth using a pillared gold substrate, rather than a planar one. The disclosed methods are believed to provide dendrites that preferentially grow out from a sharp pillar tip. Without wishing to be bound by a particular theory, it is believed that better control of dendrite growth may result in a more finely tuned chip, with less variability from sample to sample.

Preparation of a biosensor component having an adhesion layer fabrication, i.e., deposition of an adhesion layer 200 on a planar substrate layer 100, can be carried out by a suitable deposition method, including, but not limited to, an atomic layer deposition (ALD) process, a chemical vapor deposition (CVD) process, or a sputtering process, e.g., DC magnetron sputtering, comprising sputtering of a suitable material for the adhesion layer 200, e.g., tungsten, titanium, chromium, nickel, and combinations thereof, onto a suitable planar substrate layer 100. Sputtering parameters, e.g., power, pressure, temperature, time/duration, and other parameters as known to the skilled artisan, in order to achieve the desired thickness of the adhesion layer 200. In some aspects, the adhesion layer 200 can be deposited on the the planar substrate layer 100 using electrodeposition processes. Similar techniques can be utilized to carry out fabrication of a biosensor component having a WE layer 300 on the adhesion layer 200.

Following preparation of the WE layer 300, fabrication of a biosensor component having a dendritic layer 400 comprises: (a) fabrication of metallic pillared dendrites 800, which are in contact with the WE layer 300; and (b) coating of the metallic pillared dendrites 800 with a conductive polymer layer 700, thereby forming the the dendritic layer 400. It is to be understood, as discussed above, that the polymer layer 700 comprises a dendrite conductive polymer layer 701, which is in contact with metallic pillared dendritic structures formed in (a), which is in contact with the WE conductive polymer layer 702, which is in contact with any portion of the WE layer 300 that is exposed and not in contact with the metallic pillared dendrites 800.

Fabrication of metallic pillared dendrites 800, which are in contact with the WE layer 300, can be carried out using electro-deposition methods with a waveform generator using a two-electrode setup, in which the waveform can be monitored using an oscilloscope during electro-deposition. Briefly, the biosensor component having a WE layer 300, prepared as described above, is immersed in an electrolyte solution, and a counter electrode is also immersed in the electrolyte solution. The biosensor component having a WE layer 300 serves as the working electrode for the electro-deposition, and the counter electrode can be a suitable metal such as a platinum wire. The electrolyte solution comprises a salt appropriate for the type of metallic pillared dendrites 800 that are to be formed. For example, if the metallic pillared dendrites 800 that are to be formed are gold, then the electrolyte solution would comprise ions from a gold salt, e.g., HAuCl₄, prepared at a suitable concentration. The waveform generator is used to generate a suitable waveform using the two electrodes, e.g., a square waveform having a suitable frequency, peak-to-peak amplitude, offset, duty cycle, and duration.

In various aspects, the electrolyte solution is prepared at a concentration of from about 1 mM to about 1 M using a salt comprising a cation of the target metal of the metallic pillared dendrites 800. In a further, the electrolyte solution is prepared at a concentration of from about 1 mM to about 100 mM using a salt comprising a cation of the target metal of the metallic pillared dendrites 800. In a still further, the electrolyte solution is prepared at a concentration of from about 10 mM to about 50 mM using a salt comprising a cation of the target metal of the metallic pillared dendrites 800.

In various aspects, the electrolyte solution is prepared at a concentration of from about 1 mM to about 1 M using a salt comprising a gold cation, wherein the salt is HAuCl₄. In a further, the electrolyte solution is prepared at a concentration of from about 1 mM to about 100 mM using a salt comprising a gold cation, wherein the salt is HAuCl₄. In a still further, the electrolyte solution is prepared at a concentration of from about 10 mM to about 50 mM using a salt comprising a gold cation, wherein the salt is HAuCl₄.

In various aspects, the waveform used for the preparation metallic pillared dendrites 800 utilizes a frequency of about 0.5 MHz to about 500 MHz; a square, sine, or triangle waveform shape; a peak-to-peak of about 6 V to about 24 V; a peak-to-peak amplitude of about 1/16 to about ¼; a duty cycle of about 10% to about 90%; and a duration of about 30 seconds to about 1 hour. In a further aspect, the waveform used for the preparation metallic pillared dendrites 800 utilizes a frequency of about 1 MHz to about 100 MHz; a square or triangle waveform shape; a peak-to-peak of about 8 V to about 16 V; a peak-to-peak amplitude of about 1/12 to about ⅙; a duty cycle of about 30% to about 70%; and a duration of about 3 minutes to about 30 minutes. In a still further aspect, the waveform used for the preparation metallic pillared dendrites 800 utilizes a frequency of about 10 MHz to about 50 MHz; a square or triangle waveform shape; a peak-to-peak of about 10 V to about 16 V; a peak-to-peak amplitude of about 1/9 to about 1/7; a duty cycle of about 40% to about 60%; and a duration of about 10 minutes to about 20 minutes. The metallic pillared dendrites 800 formed can be assessed by a suitable method, e.g., scanning electron microscopy.

In various aspects, the preparation metallic pillared dendrites 800 uses a solution comprising about 1 mM to about 1 M HAuCl₄ and a waveform with the following parameters: a frequency of about 0.5 MHz to about 500 MHz; a square, sine, or triangle waveform shape; a peak-to-peak of about 6 V to about 24 V; a peak-to-peak amplitude of about 1/16 to about ¼; a duty cycle of about 10% to about 90%; and a duration of about 30 seconds to about 1 hour. In a further aspect, the preparation metallic pillared dendrites 800 uses a solution comprising about 1 mM to about 100 mM HAuCl₄ and a waveform with the following parameters: a frequency of about 1 MHz to about 100 MHz; a square or triangle waveform shape; a peak-to-peak of about 8 V to about 16 V; a peak-to-peak amplitude of about 1/12 to about ⅙; a duty cycle of about 30% to about 70%; and a duration of about 3 minutes to about 30 minutes. In a still further aspect, the preparation metallic pillared dendrites 800 uses a solution comprising about 10 mM to about 30 mM HAuCl₄ and a waveform with the following parameters: a frequency of about 10 MHz to about 50 MHz; a square or triangle waveform shape; a peak-to-peak of about 10 V to about 16 V; a peak-to-peak amplitude of about 1/9 to about 1/7; a duty cycle of about 40% to about 60%; and a duration of about 10 minutes to about 20 minutes.

The dendritic structures prepared as described above are further funcationalize to comprise a conductive polymer coating, wherein the conductive polymer is of a type as described herein above. Fabrication of the conductive polymer coating utilizes a three electrode system, e.g., in which the metallic pillaried dendrites 800 on the underlying WE layer 300 served as the working electrode, a reference electrode such as an external Ag/AgCl wire, a counter electrode such as an external platinum wire, with suitable monomers at a suitable concentration in a suitable conductive solvent, further comprising an appropriate electrolyte, carried out a suitable voltage for suitable period of time. For example, the conductive polymer coating formed is PCEPy, and the method comprises using about 5 mM to about 30 mM (2-cyano)pyrrole with about 10 mM to about 200 mM NaClO₄ as the electrolyte at about 500 mV to about 1000 mV for about 10 seconds to about 200 seconds. In a further aspect, the conductive polymer coating formed is PCEPy, and the method comprises using about 5 mM to about 15 mM (2-cyano)pyrrole with about 75 mM to about 150 mM NaClO₄ as the electrolyte at about 700 mV to about 900 mV for about 75 seconds to about 150 seconds. In a still further aspect, the conductive polymer coating formed is PCEPy, and the method comprises using about 10 mM (2-cyano)pyrrole with about 100 mM NaClO₄ as the electrolyte at about 800 mV for about 100 seconds. The coated biosensor component can be characterized using a DPV scan, e.g., a DPV scan in a suitable voltage to encompass the oxidation potential of the conductive polymer. For example, in the instance in which the conductive polymer is PCEPy, then a suitable DPV scan may utilize a voltage range of 0-700 mV, which encompasses the oxidation potential of this polymer. In this instance, a peak around 400 mV is indicative of the generation of a PCEPy layer or coating.

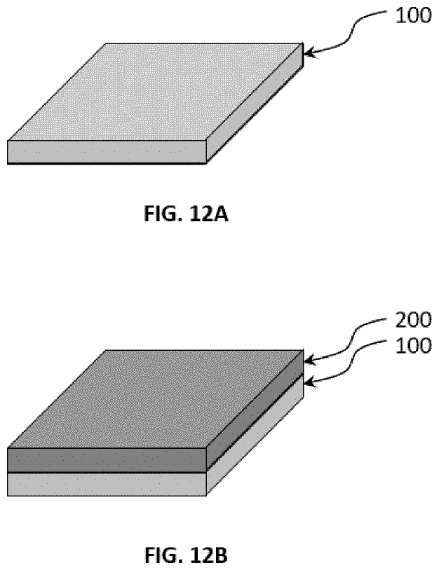

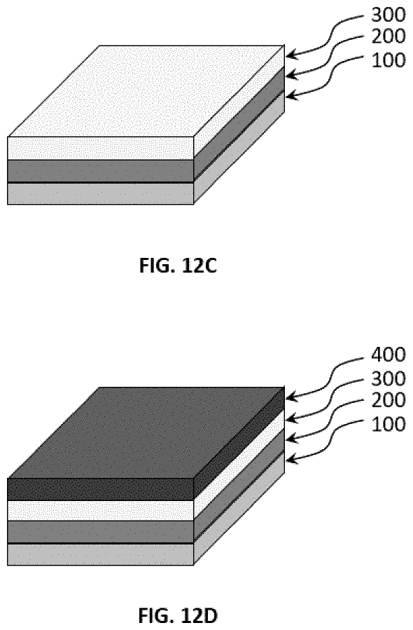

Referring now to FIGS. 12A-12D, these figures show representative perspective diagram views showing appearance of disclosed biosensor layers during various fabrication steps to a prepare a biosensor component having a substrate layer 100, an adhesion layer 200, a WE layer 300, and a dendritic layer 400. FIG. 12A shows a representative perspective diagram view of a substrate layer 100 prior to deposition of an adhesion layer 200. FIG. 12B shows a representative perspective diagram view of a substrate layer 100 after deposition of an adhesion layer 200. FIG. 12C shows a representative perspective diagram view of a substrate layer 100 after deposition of an adhesion layer 200 and deposition of a WE layer 300. FIG. 12D shows a representative perspective diagram view of a substrate layer 100 after deposition of an adhesion layer 200 and deposition of a WE layer 300, followed by preparation of a dendritic layer 400. Although, for example, FIG. 12D shows a multilayered disclosed biosensor component have essentially square geometry when viewed from above a dendritic layer 400, a disclosed biosensor component can have any suitable geometry from said perspective, e.g., rectangular, oval, circular and the like.

### D. METHODS OF USING THE DISCLOSED BIOSENSORS

In various aspects, the present disclosure pertains to methods of using the disclosed biosensors with one or more antibodies to detect a target analyte. Although disclosed herein in the examples are use of the disclosed sensors for detection of cholera toxin subunit B, applications of the disclosed methods of detecting an analyte are not limited to cholera detection. For example, other analytes associated with a particular disease, e.g., a disease-related biomarker for which there are effective antibodies commercially available, can be detected using the disclosed biosensors, e.g., in an on-chip device of the present disclosure. In a particular aspect, the analyte is a biomarker or protein associated with an infection of a patient by a particular infectious disease agent, e.g., bacteria or virus.

In a further aspect, the analyte is a component of a bacterial cell which can be bound by an antibody. In a still further aspect the bacteria is a gram positive bacteria. In another aspect the bacteria is a gram negative bacteria. In a yet further aspect, the bacterial cell is a pathogenic bacterial cell. Pathogenic bacteria are bacteria that can cause infection. The pathogenic bacteria or pathogenic bacterial cells may for example be selected from the group consisting of Vibrio, Streptococcus, Staphylococcus, Escherichia, Shigella, Salmonella, Neisseria, Brucella, Mycobacterium, Nocartha, Listeria, Francisella, Legionella, Borrelia, Chlamydia, Helicobacter, Pseudomonas and Yersinia. In an even further aspect, the bacteria is Escherichia coli. In a still further aspect, the bacteria is Vibrio cholerae.

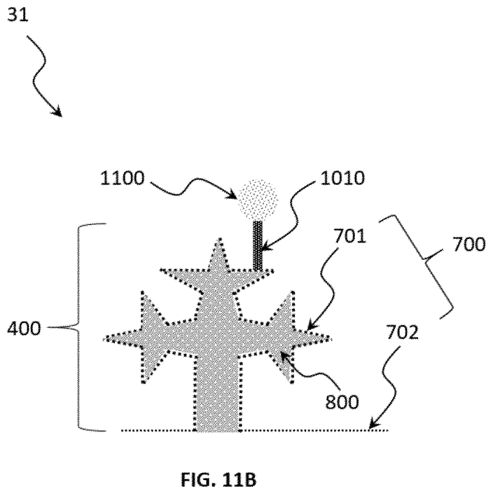

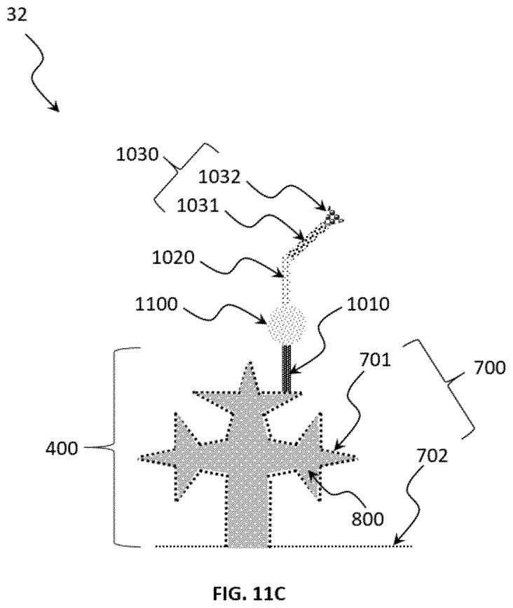

In a further aspect, the disclosed method of using the disclosed biosensors to detect a target analyte. For example, the biosensor component comprising a substrate layer 100, an adhesion layer 200, a WE layer 300, and a dendritic layer 400 with a sample chamber 600 is used, and introduced into the sample chamber 600 is a primary analyte antibody 1010 (i.e., a primary antibody binding step) at a suitable concentration in a suitable buffer and incubated in the sample chamber 600 for a suitable period of time at a suitable temperature. For example, if the target analyte is CTX, an antibody that binds CTX can be used at a concentration of about 0.1 mg/mL to about 10 mg/mL in a buffer solution comprising about 1 mM HEPES to about 100 mM HEPES at a pH of about 7.0 to about 7.6 for about 1 hour to about 72 hours at a temperature of about 4° C. to about 10° C. Following the primary antibody incubation step, the biosensor component can be washed and blocked, e.g., rinsed for one time to ten times with a suitable wash solution such as TBST (as described in the examples herein below), followed by blocking with a suitable blocking solution such as BSA/glycerol in TBST (as described in the examples herein below) for a suitable period time, e.g., about 30 minutes to about 2 hours, at a suitable temperature, e.g., about 10° C. to about 30° C. Other washing and blocking solutions are possible as known to the skilled artisan, and can be chosen to optimize sensitivity of detection of the target analyte and minimize non-specific interactions, i.e., optimize the signal-to-noise response of analyte detection. The number of rinse steps, during of rinse steps, and conditions for blocking can be altered to optimize sensitivity of detection of the target analyte and minimize non-specific interactions. Without wishing to be bound by a particular theory, the washing and blocking steps are believed to prevent non-specific binding of materials to the biosensor component, including the sample chamber 600 and/or reactive sites in the conductive polymer. Referring now to FIG. 11A, which shows a representative biosensor component detail portion showing the detail portion in which a primary analyte antibody 1010 is in contact with a dendrite conductive polymer layer 701 of a dendritic layer 400 following the primary analyte incubation step.

The method further comprises: (a) an analyte incubation step; (b) a secondary analyte antibody incubation step; (c) a tertiary detection antibody incubation step; and (d) a detection step. Briefly, in the analyte incubation step the analyte is introduced to the sample chamber 600 following the primary antibody incubation step, and the analyte incubated for a suitable period of time at a suitable temperature, followed by washing as described above. The analyte can be a suitably prepared clinical sample, e.g., a patient sample. Referring now to FIG. 11B, which shows a representative biosensor component detail portion showing the detail portion in which a primary analyte antibody 1010 is in contact with dendritic layer 400 and the analyte 1100 following the analyte incubation step. It is understood that the primary analyte antibody 1010 recognizes and binds, e.g., specifically binds, to an analyte.

In the secondary analyte antibody incubation step, the secondary analyte antibody is introduced to the sample chamber 600 following the foregoing analyte incubation step, and the secondary analyte antibody incubated for a suitable period of time at a suitable temperature, followed by washing as described above. For example, if the target analyte is CTX, the secondary analyte antibody is an antibody that binds CTX. In this example, the secondary analyte antibody can be used at a concentration of about 0.1 mg/mL to about 10 mg/mL in a buffer solution, e.g., TBST (as described in the examples herein below), for about 1 hour to about 72 hours at a temperature of about 4° C. to about 10° C. Following the secondary analyte antibody incubation step, the biosensor component can be washed with a suitable wash solution such as TBST (as described in the examples herein below).

In the tertiary detection antibody incubation step, the tertiary detection antibody is introduced to the sample chamber 600 following the foregoing secondary analyte antibody incubation step, and the tertiary detection antibody incubated for a suitable period of time at a suitable temperature, followed by washing as described above with a suitable buffer solution, e.g., TBST (as described in the examples herein below). The tertiary detection antibody comprises an antibody that generally detects the species and/or class of antibody of the secondary analyte antibody. For example, if the secondary analyte antibody is a mouse IgG, then the tertiary detection antibody comprises an antibody that recognizes and binds to mouse IgG antibodies. The tertiary detection antibody further comprises a detection enzyme that is conjugated or covalently linked to the antibody portion of the tertiary detection antibody.

In various aspects, the detection step comprises electrochemical ELISA methods. Referring now to FIG. 11C, which shows a representative biosensor component detail portion showing the detail portion in which a primary analyte antibody 1010 is in contact with dendritic layer 400 and an analyte 1100, wherein a secondary analyte antibody 1020 is in contact with the analyte 1100, and wherein a tertiary detection antibody 1030, comprising a tertiary antibody 1031 conjugated to a detection enzyme 1032, is in contact with the secondary analyte antibody 1020. It is understood that the primary analyte antibody 1020 recognizes and binds, e.g., specifically binds, to an analyte and to an epitope on the primary analyte antibody 1010. It is also understood that the tertiary antibody 1031 recognizes and binds, e.g., specifically binds, an epitope on the secondary analyte antibody 1020.

A suitable enzyme is one that can catalyze a chemical reaction on a suitable substrate to yield a substrate product that can be detected electrochemically, e.g., under suitable differential pulse voltammetry conditions. For example, the tertiary detection antibody can comprise an antibody that binds mouse IgG, wherein the antibody is conjugated to a suitable enzyme, including, but not limited to, a cellulose, a phosphate, such as an alkaline phosphatase, or a peroxidase. For example, an alkaline phosphatase can catalyze the conversion of pAPP to 4-AP, which oxidizes at about −100 mV versus a pseudo Ag/AgCl reference electrode.

Briefly, the detection step comprises providing a suitable substrate, i.e., a detectable substrate that can undergo a chemical reaction catalyzed by the detection enzyme 1030 to yield a detection product compound that is capable of electrochemical detection, e.g., using cyclic voltammetry, differential pulse voltammetry, square wave voltammetry, impedance spectroscopy, chronoamperometry, or chronocoulometry. In another embodiment the electrochemical detection employs cyclic voltammetry and chronocoulometry.

Suitable primary analyte antibodies and secondary analyte antibodies can be determined by the skilled artisan to detect the presence of a particular infectious disease vector, e.g., a bacteria or virus associated with an infectious disease. The infectious disease which is desired to be detected can be in a human patient or subject, or alternatively, can be an infectious disease associated with a non-human subject.

In a further aspect, the present disclosure provides methods of detecting an infectious disease such as a Gram positive bacterial infection. In a still further aspect, the Gram positive bacteria is selected from Bacillus sp. Clostridium sp., Corynebacterium sp, Enterococcus sp., Mycoplasma sp., Staphylococcus sp., and Streptococcus sp. In yet a further aspect, the Gram positive bacteria is vancomycin resistant Enterococcus sp. (VRE). In an even further aspect, the Gram positive bacteria is methicillin resistant Staphylococcus sp. (MRS). In a still further aspect, the Gram positive bacteria is selected from Bacillus anthracis, Bacillus cereus, Bacillus subtilis, Clostridium difficile, Clostridium tetani, Clostridium botulinum, Clostridium perfringens, Corynebacterium diphtheria, Enterococcus faecalis, Enterococcus faecium, Listeria monocytogenes, Listeria ivanovii, Micrococcus luteus, Mycoplasma genitalium, Mycoplasma pneumoniae, Staphylococcus aureus, Staphylococcus epidermidis, Staphylococcus saprophyticus, Staphylococcus hyicus, Staphylococcus intermedius, Streptococcus pneumoniae, and Streptococcus pyogenes. In yet a further aspect, the Gram positive bacteria is selected from Bacillus anthracis, Bacillus subtilis, Enterococcus faecalis, Staphylococcus aureus, Streptococcus pneumoniae, and Streptococcus pyogenes. In an even further aspect, the Gram positive bacteria is selected from vancomycin resistant Enterococcus faecalis, vancomycin resistant methicillin resistant Enterococcus faecium, Staphylococcus aureus (MRSA), methicillin resistant Staphylococcus epidermidis (MRSE), macrolide resistant Streptococcus pneumoniae (Mac-R SPN) and penicillin resistant Streptococcus pneumonia (PRSP).

In a further aspect, the present disclosure provides methods of detecting an infectious disease such as a Gram negative bacterial infection. In a still further aspect, the Gram negative bacteria is selected from Acinetobacter sp., Aeromonas sp., Burkholderia sp., Bordatella sp., Citrobacter sp., Chlamydia sp., Enterobacter sp., Escherichia sp., Francisella sp., Haemophilus sp., Klebsiella sp., Legionella sp., Moraxella sp., Neisseria sp., Proteus sp., Pseudomonas sp., Rickettsia sp., Salmonella sp., Shigella sp., Stenotrophomonas sp., Vibrio sp., and Yersinia sp. In yet a further aspect, the Gram negative bacteria is selected from Acinetobacter baumannii, Aeromonas hydrophila, Bordetella pertussis, Bordetella parapertussis, Bordetella bronchiseptica, Burkholderia cepacia, Citrobacter freundii, Chlamydia pneumoniae, Chlamydia trachomatis, Chlamydia psittaci, Enterobacter aerogenes, Enterobacter cloacae, Enterobacter sakazakii, Escherichia coli, Francisella tularensis, Haemophilus influenzae, Haemophilus aegypticus, Haemophilus ducreyi, Klebsiella edwardsii, Klebsiella pneumoniae, Legionella pneumophilia, Moraxella catarrhalis, Neisseria meningitidis, Neisseria gonorrhoeae, Proteus mirabilis, Proteus vulgaris, Pseudomonas aeruginosa, Rickettsia rickettsii, Rickettsia akari, Rickettsia conorrii, Rickettsia sibirica, Rickettsia australis, Rickettsia felis, Rickettsia japonica, Rickettsia africae, Rickettsia prowazekii, Rickettsia typhi, Salmonella enterica, Shigella boydii, Shigella dysenteriae, Shigella flexneri, Shigella sonnei, Stenotrophomonas maltophilia, Vibrio cholerae, Vibrio parahaemolyticus, Vibrio vulnificus, Vibrio fluvialis, Yersinia pestis, Yersina enterocolitica, and Yersina pseudotuberculosis.

In a further aspect, the Gram negative bacteria is a multi-drug resistant Gram negative bacteria strain (MDR-GNB). In a still further aspect, the multi-drug resistant Gram negative bacteria strain (MDR-GNB) is resistant to at least one anti-microbial agent selected from amikacin, tobramycin, cefepime, ceftazidime, imipenem, meropenem, piperacillin-tazobactam, ciprofloxacin, levofloxacin, tigecycline, and polymyxin B. In yet a further aspect, the multi-drug resistant Gram negative bacteria strain (MDR-GNB) is selected from Acinetobacter sp., Enterobacter sp., Klebsiella sp., and Pseuodomonas sp. In an even further aspect, the multi-drug resistant Gram negative bacteria strain (MDR-GNB) is selected from Acinetobacter baumannii, Enterobacter aerogenes, Klebsiella pneumoniae, and Pseudomonas aeruginosa. In a still further aspect, the multi-drug resistant Gram negative bacteria strain (MDR-GNB) is Enterobacter sp.

In a further aspect, the present disclosure provides methods of detecting an infectious disease selected from atypical pneumonia, bacterial meningitis, bronchitis, cholera, dental infection, dermatitis, diarrhea, diphtheria, dysentery, ear infection, endocarditis, gastritis, gastroenteritis, genital infection, genitourinary infection, infection associated with an indwelling device, intestinal infection, leprosy, listeriosis, lung infection, nocosomial infection, ocular infection, oral infection, otitis, osteo-articular infection, osteomyelitis, pharyngitis, papules, pharyngitis, pneumonia, pneumonia conjunctivitis, pruritius, pustules, pyoderma, pyothorax, respiratory infection, salmonellosis, septicemia, sexually transmitted disease, sinusitis, skin infection, skin and soft tissue infection (“SSTI”), soft tissue infection, tetanus, tuberculosis, typhus, ulcer, urinary tract infection, and wound infection. In a still further aspect, the infectious disease is selected from endocardititis, osteomyelitis, skin and soft tissue infection (“SSTI”), and infection associated with an indwelling device. In yet a further aspect, the infectious disease is endocardititis. In an even further aspect, the infectious disease is osteomyelitis. In a still further aspect, the infectious disease is an SSTI. In yet a further aspect, the SSTI is a complicated SSTI (cSSTI). In an even further aspect, the infectious disease is associated with an indwelling device.

Also provided are methods for the detection of a bacterial infection in a vertebrate animal. In some aspects, the vertebrate animal is a mammal. In a further aspect, the vertebrate animal is a fish, a bird, or a mammal. In a still further aspect, the vertebrate animal is a livestock animal. In yet a further aspect, the vertebrate animal is a companion animal. In an even further aspect, the vertebrate animal is a farm animal. In a still further aspect, the vertebrate animal is a zoo animal. In yet a further aspect, the vertebrate animal is a laboratory animal. In an even further aspect, the vertebrate animal is an aquaculture fish. In a still further aspect, the vertebrate animal is selected from Bison sp., Bos sp., Canis sp., Capra sp., Equus sp., Felis sp., Gallus sp., Lama sp., Meleagris sp., Oryctolagus sp., Ovis sp., and Sus sp.

In various aspects, the WE layer, RE, and CE of the disclosed biosensors can be connected to a potentiostat, including a potentiostat as described herein below. The potentiostat in turn can be connected to a suitable computing device in order to carry signal processing and data output for the methods described herein below. Accordingly, the methods described herein can be utilized with an analyte detection system comprising a disclosed biosensor.

From the foregoing, it will be understood that various aspects of the analyte detection system comprising a disclosed biosensor described herein can comprise software processes that execute on computer systems that form parts of the system. Accordingly, it will be understood that various aspects of the system described herein are generally implemented as specially-configured computers including various computer hardware components and, in many cases, significant additional features as compared to conventional or known computers, processes, or the like, as discussed in greater detail herein. Aspects within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the aspects of the claimed disclosures may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Aspects of the claimed disclosure are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the disclosures are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the disclosure is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred aspect, additional aspects, features, and methodologies of the claimed disclosures will be readily discernible from the description herein, by those of ordinary skill in the art. Many aspects and adaptations of the disclosure and claimed disclosures other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed disclosures. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed disclosures. In addition, some steps may be carried out simultaneously, contemporaneously, or in synchronization with other steps.

From the foregoing, it will be seen that aspects herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only, and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### E. REFERENCES

References are cited herein throughout using the format of reference number(s) enclosed by parentheses corresponding to one or more of the following numbered references. For example, citation of references numbers 1 and 2 immediately herein below would be indicated in the disclosure as (1, 2) or (1-2).

(1) Cholera count reaches 500 000 in Yemen; World Health Organization (WHO), http://www.who.int/news-room/detail/14-08-2017-cholera-count-reaches-500-000-in-yemen (accessed Jul. 16, 2018).

(2) Cederquist, K. B.; Kelley, S. O. Nanostructured Biomolecular Detectors: Pushing Performance at the Nanoscale. Curr. Opin. Chem. Biol. 2012, 16 (3-4), 415-421.

(3) Chin, C. D.; Linder, V.; Sia, S. K. Lab-on-a-Chip Devices for Global Health: Past Studies and Future Opportunities. Lab Chip 2007, 7 (1), 41-57.

(4) Kawasaki, J. K.; Arnold, C. B. Synthesis of Platinum Dendrites and Nanowires Via Directed Electrochemical Nanowire Assembly. Nano Lett. 2011, 11 (2), 781-785.

(5) Flanders, B. N. Directed Electrochemical Nanowire Assembly: Precise Nanostructure Assembly via Dendritic Solidification. Mod. Phys. Lett. B 2012, 26 (01), 1130001.

(6) Rashid, M. H.; Mandal, T. K. Synthesis and Catalytic Application of Nanostructured Silver Dendrites. J. Phys. Chem. C 2007, 111 (45), 16750-16760.

(7) Wen, X.; Xie, Y.-T.; Mak, W. C.; Cheung, K. Y.; Li, X.-Y.; Renneberg, R.; Yang, S. Dendritic Nanostructures of Silver: Facile Synthesis, Structural Characterizations, and Sensing Applications. Langmuir 2006, 22 (10), 4836-4842.

(8) Das, J.; Kelley, S. O. Protein Detection Using Arrayed Microsensor Chips: Tuning Sensor Footprint to Achieve Ultrasensitive Readout of CA-125 in Serum and Whole Blood. Anal. Chem. 2011, 83 (4), 1167-1172.

(9) Paneru, G.; Flanders, B. N. Complete Reconfiguration of Dendritic Gold. Nanoscale 2014, 6 (2), 833-841.

(10) Bhimji, A.; Zaragoza, A. A.; Live, L. S.; Kelley, S. O. Electrochemical Enzyme-Linked Immunosorbent Assay Featuring Proximal Reagent Generation: Detection of Human Immunodeficiency Virus Antibodies in Clinical Samples. Anal. Chem. 2013, 85 (14), 6813-6819.

(11) Adhikari, B.; Majumdar, S. Polymers in Sensor Applications. Prog. Polym. Sci. 2004, 29, 699-766.

(12) Ramanavicius, A.; Ramanaviciene, A.; Malinauskas, A. Electrochemical Sensors Based on Conducting Polymer□Polypyrrole. Electrochim. Acta 2006, 51 (27), 6025-6037.

(13) Wang, L.-X.; Li, X.-G.; Yang, Y.-L. Preparation, Properties and Applications of Polypyrroles. React. Funct. Polym. 2001, 47 (2), 125-139.

(14) Khan, W.; Kapoor, M.; Kumar, N. Covalent Attachment of Proteins to Functionalized Polypyrrole-Coated Metallic Surfaces for Improved Biocompatibility. Acta Biomater. 2007, 3 (4), 541-549.

(15) Uang, Y.-M.; Chou, T.-C. Fabrication of Glucose Oxidase/Polypyrrole Biosensor by Galvanostatic Method in Various PH Aqueous Solutions. Biosens. Bioelectron. 2003, 19 (3), 141-147.

(16) Rodriguez, M. I.; Alocilja, E. C. Embedded DNA-Polypyrrole Biosensor for Rapid Detection of Escherichia Coli. IEEE Sens. J. 2005, 5 (4), 733-736.

(17) Ouerghi, O.; Senillou, A.; Jaffrezic-Renault, N.; Martelet, C.; Ben Ouada, H.; Cosnier, S. Gold Electrode Functionalized by Electropolymerization of a Cyano N-Substituted Pyrrole: Application to an Impedimetric Immunosensor. J. Electroanal. Chem. 2001, 501 (1), 62-69.

(18) Um, H.-J.; Kim, M.; Lee, S.-H.; Min, J.; Kim, H.; Choi, Y.-W.; Kim, Y.-H. Electrochemically Oriented Immobilization of Antibody on Poly-(2-Cyano-Ethylpyrrole)-Coated Gold Electrode Using a Cyclic Voltammetry. Talanta 2011, 84 (2), 330-334.

(19) Diaz, A. F.; Castillo, J.; Kanazawa, K. K.; Logan, J. A.; Salmon, M.; Fajardo, O. Conducting Poly-N-Alkylpyrrole Polymer Films. J. Electroanal. Chem. Interfacial Electrochem. 1982, 133 (2), 233-239.

(20) Nesbitt, N. T.; Ma, M.; Trześniewski, B. J.; Jaszewski, S.; Tafti, F.; Burns, M. J.; Smith, W. A.; Naughton, M. J. Au Dendrite Electrocatalysts for CO2 Electrolysis. J. Phys. Chem. C 2018, 122 (18), 10006-10016.

(21) Archibald, M. M.; Rizal, B.; Connolly, T.; Burns, M. J.; Naughton, M. J.; Chiles, T. C. A Nanocoaxial-Based Electrochemical Sensor for the Detection of Cholera Toxin. Biosens. Bioelectron. 2015, 74, 406-410.

(22) Li, J.; Liu, J.; Tan, G.; Jiang, J.; Peng, S.; Deng, M.; Qian, D.; Feng, Y.; Liu, Y. High-Sensitivity Paracetamol Sensor Based on Pd/Graphene Oxide Nanocomposite as an Enhanced Electrochemical Sensing Platform. Biosens. Bioelectron. 2014, 54, 468-475.

(23) Jawetz, E.; Melnick, J. L.; Adelberg, E. A. Review of Medical Microbiology, 15th ed.; Lange Medical: Los Altos, Calif., USA, 1982.

(24) Zayats, M.; Raitman, O. A.; Chegel, V. I.; Kharitonov, A. B.; Willner, I. Probing Antigen-Antibody Binding Processes by Impedance Measurements on Ion-Sensitive Field-Effect Transistor Devices and Complementary Surface Plasmon Resonance Analyses: Development of Cholera Toxin Sensors. Anal. Chem. 2002, 74 (18), 4763-4773.

(25) Ramamurthy, T.; Bhattacharya, S. K.; Uesaka, Y.; Horigome, K.; Paul, M.; Sen, D.; Pal, S. C.; Takeda, T.; Takeda, Y.; Nair, G. B. Evaluation of the Bead Enzyme-Linked Immunosorbent Assay for Detection of Cholera Toxin Directly from Stool Specimens. J. Clin. Microbiol. 1992, 30 (7), 1783-1786.

(26) Polk, B. J.; Stelzenmuller, A.; Mijares, G.; MacCrehan, W.; Gaitan, M. Ag/AgCl Microelectrodes with Improved Stability for Microfluidics. Sens. Actuators, B 2006, 114 (1), 239-247.

(27) Hassel, A. W.; Fushimi, K.; Seo, M. An Agar-Based Silver|silver Chloride Reference Electrode for Use in Micro-Electrochemistry. Electrochem. Commun. 1999, 1 (5), 180-183.

(28) Mullins, W. W.; Sekerka, R. F. Stability of a Planar Interface During Solidification of a Dilute Binary Alloy. J. Appl. Phys. 1964, 35(2), 444-451.

(29) Sharma, S.; Crawley, A.; O'Kennedy, R. Strategies for Overcoming Challenges for Decentralised Diagnostics in Resource-Limited and Catastrophe Settings. Expert Rev. Mol. Diagn. 2017, 17(2), 109-118.

(30) Hardware development; PalmSens, https://www.palmsens.com/oem/potentiostat-modules/ (accessed Sep. 12, 2018).

(31) Chiriaco, M. S.; Primiceri, E.; D'Amone, E.; Ionescu, R. E.; inaldi, R.; Maruccio, G. EIS Microfluidic Chips for Flow Immunoassay and Ultrasensitive Cholera Toxin Detection. Lab Chip 2011, 11 (4), 658-663.

(32) Labib, M.; Hedstrom, M.; Amin, M.; Mattiasson, B. A Capacitive Immunosensor for Detection of Cholera Toxin. Anal. Chim. Acta 2009, 634 (2), 255-261.

(33) Ahn-Yoon, S.; DeCory, T. R.; Baeumner, A. J.; Durst, R. A. Ganglioside-Liposome Immunoassay for the Ultrasensitive Detection of Cholera Toxin. Anal. Chem. 2003, 75 (10), 2256-2261.

(34) Viswanathan, S.; Wu, L.; Huang, M.-R.; Ho, J. A. Electrochemical Immunosensor for Cholera Toxin Using Liposomes and Poly(3,4-Ethylenedioxythiophene)-Coated Carbon Nanotubes. Anal. Chem. 2006, 78 (4), 1115-1121.

(35) Schofield, C. L.; Field, R. A.; Russell, D. A. Glyconanoparticles for the Colorimetric Detection of Cholera Toxin. Anal. Chem. 2007, 79 (4), 1356-1361.

### F. EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

The following examples are provided to illustrate aspects of the present disclosure but are by no means intended to limit its scope.

The examples described herein will be understood by one of ordinary skill in the art as exemplary protocols. One of ordinary skill in the art will be able to modify the below procedures appropriately and as necessary.

### Example 1

### Materials and Experimental Procedures

Chemicals and Reagents: Cholera toxin subunit B (CTX), ferrocenecarboxylic acid (FCA), ethanol, ethylenediaminetetraacetic acid (EDTA), poly-(2-cyano-ethyl)pyrrole (PCEPy), sodium perchlorate (NaClO4) and ferrocenecarboxylic acid (FCA), HEPES, glycerol and H₂SO₄ were purchased from Sigma-Aldrich (St. Louis, Mo.). Anti-cholera toxin subunit B polyclonal and monoclonal antibodies and alkaline phosphatase (ALP) conjugated antibody were obtained from Abnova (Taipei, Taiwan). p-Aminophenylphosphate (pAPP) was acquired from Gold Biotechnology, Inc. (St. Louis, Mo.). The BluePhos phosphatase substrate system was purchased from KPL (Gaithersburg, Md.). Hydrogen tetrachloroaurate(III) trihydrate (HAuCl4), bovine serum albumin (BSA), Tween-20, phosphate buffered saline (PBS), and Tris base were obtained from Fisher Scientific (Pittsburgh, Pa.).

Directed Electrochemical Nanowire Assembly of Dendrites: Gold electrodeposition onto Ti/Au (10 nm/120 nm) coated chips was carried out with a waveform generator (Agilent 33600A Series) using a two-electrode setup. The waveform was monitored with an oscilloscope (Agilent MSO-X 3024A) during electrochemical deposition, using a 10:1 passive probe (Agilent N2863B) to minimize the oscilloscope's disturbance of the waveform. The Au film served as the working electrode (WE), and a platinum wire as the counter electrode (CE). A square waveform with frequency of 30 MHz, peak-to-peak amplitude of 10 V, offset of −1.25 V, and duty cycle of 50% was applied for 20 min in a solution of 30 mM HAuCl₄.

Poly-(2-cyano-ethyl)pyrrole Deposition and Chip Biofunctionalization: Biofunctionalization was carried out in a 3-electrode system: the gold chip surface served as the WE, an Ag/AgCl wire as the pseudo-reference electrode, and a platinum wire as the CE. A PCEPy film was formed using 10 mM 2-cyano-ethylpyrrole in 0.1 M NaClO₄ (acting as an electrolyte). The pyrrole monomer was electrooxidized at 800 mV for 100 seconds. To confirm the generation of a PCEPy coated dendrite chip, the electrode was then washed thoroughly in diH₂O, and an aqueous NaClO₄ solution containing no monomer was applied. Differential pulse voltammetry (DPV) was performed in a range of 0 to 700 mV. A peak around 400 mV is in good agreement with the oxidation potential of PCEPy.

PCEPy Dendrite Characterization: To confirm electrical integrity of the chip post-polymer coating, 0.1 M FCA was applied. Potential was swept from 0 to 500 mV, with FCA's redox peak occurring at 300 mV by DPV. To assess the increase in surface area over a planar control, cyclic voltammetry was performed as previously described. Briefly, the working electrode was the Au sample, the reference electrode was Ag/AgCl in saturated KCl solution, and the counter electrode was a Pt wire spiral. A tape mask exposed a geometric surface area of 2 cm² of the Au working electrode to the electrolyte. All three electrodes were immersed in 500 mM H₂SO₄. Electrolytes were prepared from pure sulfuric acid and deionized water.

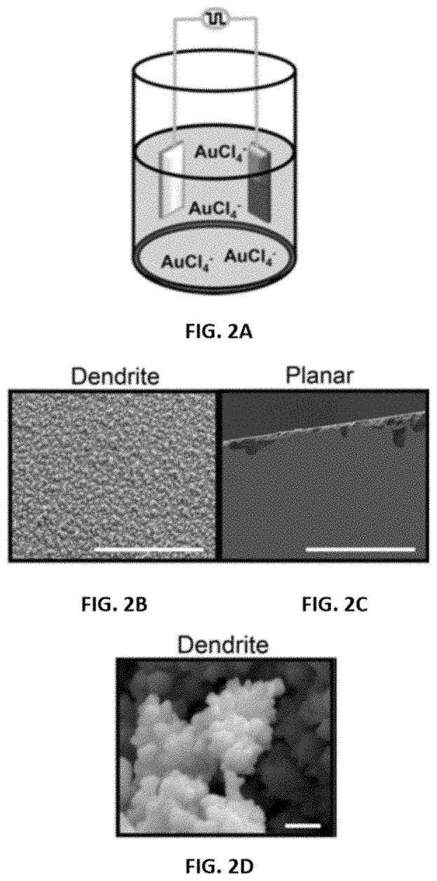

Substrate Fabrication. Sputtering was used to deposit a layer of Ti/Au (10 nm/120 nm) onto planar Si substrates. Gold electrodeposition onto Ti/Au coated chips was carried out with a waveform generator (Agilent 33600A Series) using a two-electrode setup. The waveform was monitored with an oscilloscope (Agilent MSO-X 3024A) during electrochemical deposition, using a 10:1 passive probe (Agilent N2863B) to minimize the oscilloscope's disturbance of the waveform. The Au film served as the working electrode (WE), and a platinum wire, as the counter electrode (CE) (FIG. 2A). A square waveform with frequency of 30 MHz, peak-to-peak amplitude of 10 V, offset of −2 V, and duty cycle of 50% was applied for 20 min in a solution of 30 mM HAuCl4. The WE was negatively biased relative to the CE by the voltage offset to seed and promote dendrite growth from AuCl4-anions at the base gold substrate. Resultant dendrites were analyzed by scanning electron microscopy (SEM) for the growth of dendritic structures (FIGS. 2B and 2D).

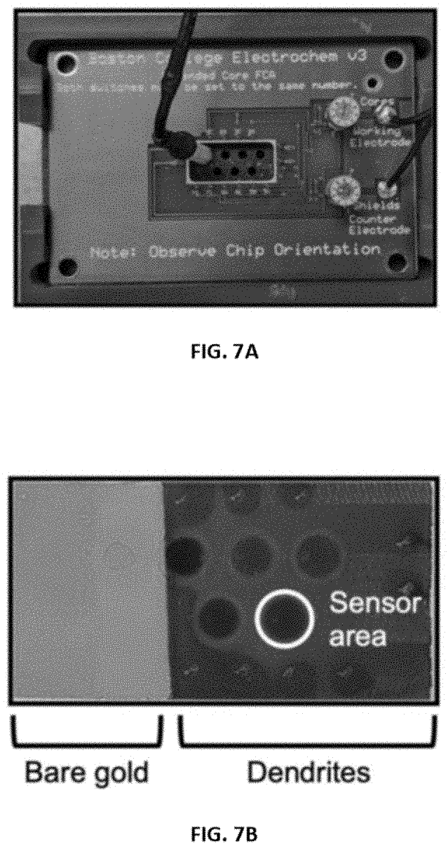

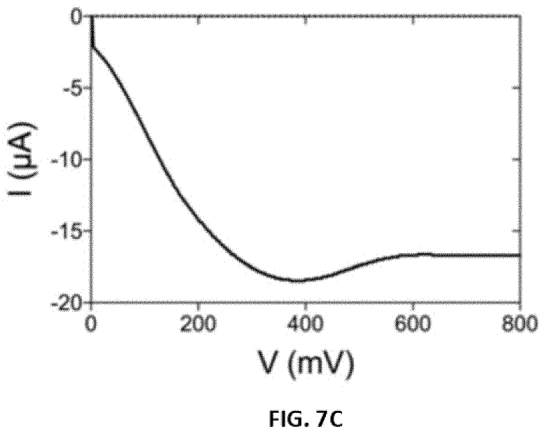

Substrate Functionalization. Functionalization was carried out in a three-electrode system (FIG. 7A): the gold chip surface served as the WE, an external Ag/AgCl wire as the RE, and an external platinum wire as the CE. A PCEPy film was formed using 10 mM (2-cyanoethyl)pyrrole in 0.1 M NaClO₄ (acting as an electrolyte). The pyrrole monomer was electrooxidized at 800 mV for 100 s. We characterized the generation of a PCEPy-coated dendrite chip via differential pulse voltammetry (DPV). Briefly, the PCEPy-coated electrode was washed thoroughly in diH₂O, and an aqueous, monomer-free NaClO₄was applied. A DPV scan was performed in a range of 0-700 mV in order to encompass the oxidation potential of PCEPy, and a peak around 400 mV was indicative of the generation of a PCEPy layer (FIGS. 7B & 7C).

Cyclic Voltammetry. To determine the increase in dendritic surface area over a planar control, cyclic voltammetry was performed to sweep across the reduction and oxidation potentials of Au. Briefly, the working electrode was the Au sample, the reference electrode was Ag/AgCl in saturated KCl solution, and the counter electrode was a Pt wire spiral. A tape mask exposed a geometric surface area of 2 cm² of the Au working electrode to the electrolyte. All three electrodes were immersed in 500 mM H₂SO₄. Electrolytes were prepared from pure sulfuric acid and deionized water.

Electrochemical ELISA: ELISAs were performed as previously described with the following modifications to allow for on-chip detection on a gold electrode. PCEPy-modified surfaces were incubated for 48 h at 4° C. with ELISA primary antibody (anti-CTX antibody) diluted to 1 mg mL⁻¹ in 10 mM HEPES. After incubation, electrodes were rinsed 3× with TBST (0.05% Tween-20, 50 mM Tris, 150 mM NaCl, pH 7.4), and blocked for 1 h at room temperature using 5% BSA and 5% glycerol in TBST, to prevent nonspecific binding to the well or to any remaining free cyano sites on the polymer. All subsequent steps (application of cholera toxin, secondary antibody, tertiary antibody, and enzyme substrate) were performed as previously described with the exception that all reagents were applied directly to the chip. In this setup, the dendrite or planar gold surface took the place of a standard plastic microtiter plate.

Differential Pulse Voltammetry. Electrochemical ELISA measurements were performed with DPV, chosen as the method for analysis due to its suppression of background current and high sensitivity. For analysis, the chip was connected to a Gamry Interface 1000 potentiostat using a three-electrode system, as previously described. The redox product 4-aminophenol (4-AP), which was generated near the surface as a result of the ELISA, was oxidized on the chip. DPV measurements were performed using a potential range of −300 to 200 mV, a potential step of 2 mV, a pulse amplitude of 50 mV, a pulse width of 50 ms, a pulse sample period of 100 ms, and an equilibrium time of 10 s. A peak around −100 mV was indicative of the oxidation of the enzymatic product 4-AP and was proportional to the amount of CTX in the sample.

### Example 2

### Fabrication of PCEPy Dendritic Microarray Sensors

Dendritic arrays were fabricated using DENA (FIG. 2A). The WE was negatively biased relative to the CE by the voltage offset to seed and promote dendrite growth from AuCl₄⁻ anions at the base gold substrate. Resultant dendrites were analyzed by scanning electron microscopy for proper dendritic growth (FIGS. 2B and 2D). A planar chip before DENA is shown imaged in on edge in FIG. 2C to aid in visualization, as the non-DENA treated surface lacks any appreciable features otherwise. Defects on the planar chip FIG. 2C are a result of the dicing process

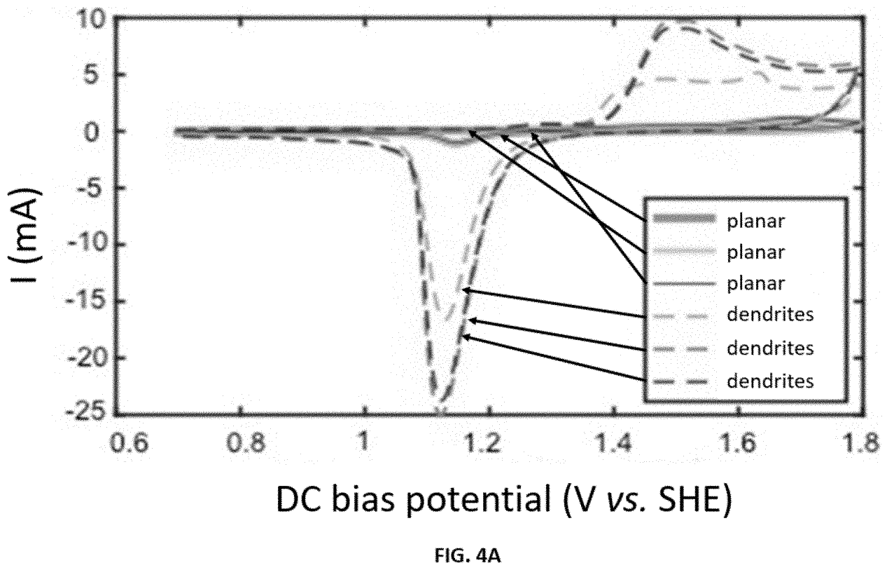

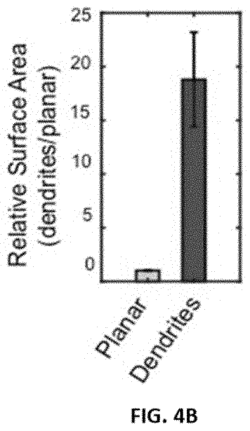

Individual dendrites demonstrate extensive branched structures that range from tens to hundreds of microns in length, increasing the surface area of the array. The increase in surface area over a planar control was assessed via cyclic voltammetry (FIG. 2A). Analysis showed the effective dendrite surface area to be approximately 18 times greater than a planar chip of the same base area (FIG. 4B).

Electrogeneration of PCEPy coated dendrites was accomplished through controlled potential oxidation at 800 mV and confirmed via DPV of a monomer-free NaClO₄ solution.

### Example 3

### Planar Electrode Functionalization

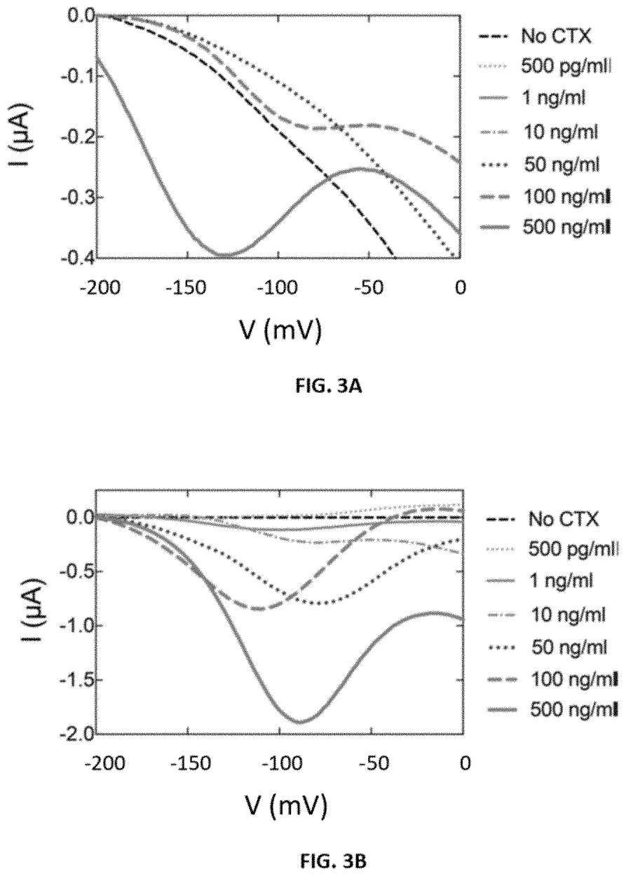

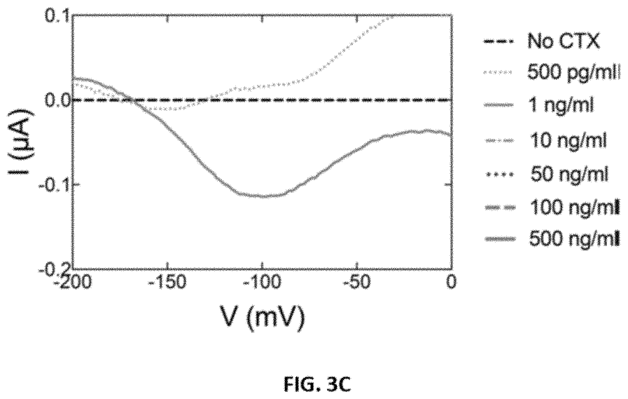

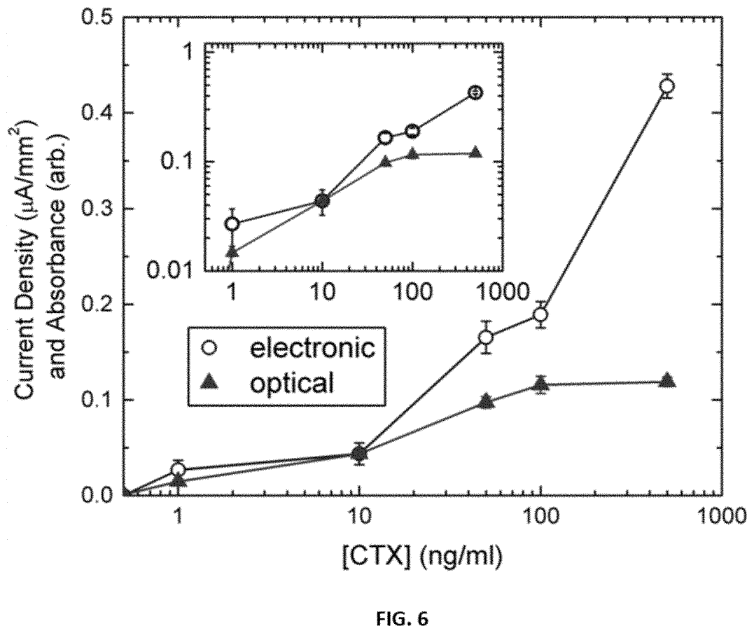

A planar goldcoated electrode represents one of the simplest substrates for electrochemical biosensor development. As such, a planar gold surface was first for the PCEPy facilitated on-chip ELISA protocol, as well as for a point of comparison for dendrite performance. The planar electrode (contained within a ˜19 mm² well) was coated in a PCEPy film, biofunctionalized with 1 mg mL⁻¹ of “capture” anti-CTX antibody, and then incubated with one of several concentrations of CTX (0.5-500 ng mL⁻¹). This range was chosen because while clinically relevant concentrations of cholera toxin fall in the picogram to nanogram range, the lethal dose of cholera toxin is ˜100 ng mL⁻¹. Additionally, a clinically available optical ELISA can detect as low as 1 ng mL⁻¹ of CTX. The ELISA protocol was performed as described above, and the 4-AP generated in the process was oxidized on the planar gold surface. A representative example titration of different concentrations of CTX detected by the planar gold electrode is shown (FIG. 3A), where the magnitude of redox peak of 4-AP at −100 mV is proportional to the amount of CTX in the sample. An ELISA of each CTX concentration was repeated in triplicate, and the average peak current was plotted against concentration (FIG. 6). It is noted that minor deviations from −100 mV are seen for the peak currents and may be attributed to a slight voltage drift likely due to the use of a pseudoreference electrode. A true reference electrode, which has an internal electrolyte with a well-defined redox couple, a nonpolarizable electrode, and a porous frit to separate the sample electrolyte from the reference electrolyte can be utilized. The small sensor cell requires the use of a microreference electrode that can either be a custom built integrated planar RE or a commercially available one.

### Example 4

### Dendritic Sensor Functionalization

The lack of sensitivity demonstrated by a simple planar gold array was likely due to the amount of surface area available for antibody tethering. To increase the amount of electrode surface area available for sensing, while maintaining a miniaturized platform, dendrites were grown off of a planar gold surface using DENA. The increase in surface area over planar was assessed via cyclic voltammetry (FIG. 4A). Analysis showed the effective dendrite surface area to be approximately 18 times greater than a planar chip of the same size footprint sensing area (FIG. 4B).

To create an electrochemical ELISA biosensor with improved on-chip detection utility vs a planar electrode, the biofunctionalization protocol described above was applied to the dendritic gold sensor. Discrete wells of 4 mm² in area were established on a sample in order to minimize the effects of surface area variability between chips (as exemplified in FIGS. 4A & 4B). DPV signals from CTX dose titrations (0.5-500 ng mL⁻¹) were measured, and a representative titration curve is shown in FIG. 3B, with lower concentrations highlighted in FIG. 3C to better visualize the 4-AP redox peak at 1 ng mL⁻¹.

Measurements were performed in triplicate, both on different chips and on different arrays on the same chip. To normalize by geometric surface area, peak current density (μA/mm²) was used to compare both architectures (FIG. 6). Despite surface area variability within and between dendrite chips, a result of the random nature of the crystallization caused by diffusion limitations, 4-AP oxidation peaks were not highly variable. It was found the dendritic on-chip ELISA assay achieved a higher sensitivity than its planar counterpart, detecting 1 ng mL⁻¹ of CTX over a smaller footprint (˜4 mm² vs ˜19 mm²), with a signal-to-noise ratio of 2.6 for this lowest concentration.

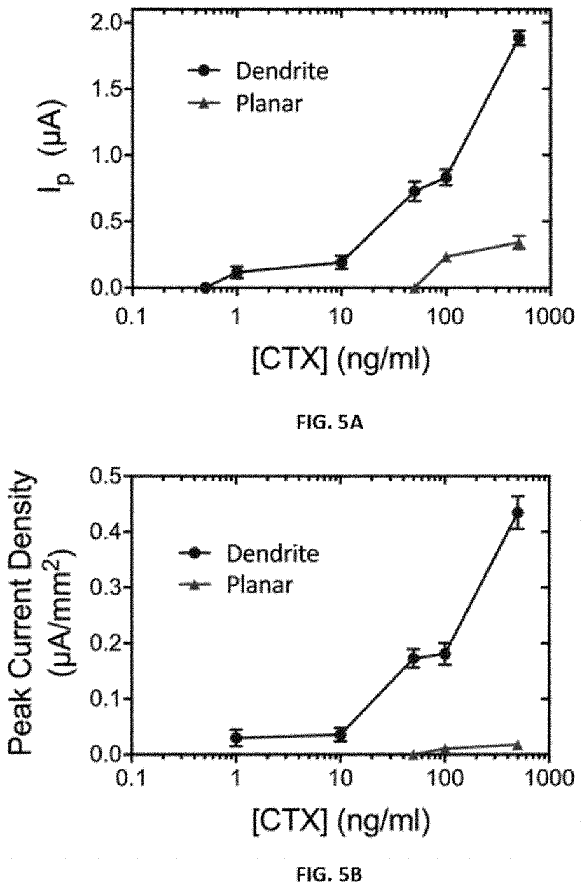

An ELISA of each CTX concentration was repeated in triplicate, and the average peak current was plotted against concentration (FIG. 5A). The lowest detectable concentration of CTX on the planar sensor was 100 ng mL−1, which is not comparable to currently available diagnostic methods. Further, the current density demonstrated by the dendrite chips was 18-25 times that of planar gold. To normalize by footprint surface area, current density was used as a final means of comparing the planar and dendritic sensors (FIG. 5B). Current density is the peak current at a specific concentration, divided by the footprint of the sensing region. The superiority of the dendritic array is better highlighted in this comparison, with dendrites on average demonstrating 18 to 25× the current density of planar gold. This number is in good agreement with the increase in surface area shown in FIG. 4B. This increase may also be attributed to the enhancement of electric fields at sharp corners, of which the dendrites have many.

Since optical-based ELISAs remain one of the best clinical methods of specifically and sensitively identifying cholera cases, the electrochemical performance of the dendrites was compared against the sensitivity of an optical ELISA using the same antibodies and reagents (FIG. 6). The dendritic on chip ELISA protocol and a standard optical ELISA both demonstrate a limit of detection of 1 ng mL⁻¹ of CTX.

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A biosensor comprising:
a substrate layer;
an adhesion layer;
a working electrode layer; and
a dendritic layer;
wherein the dendritic layer comprises a conductive polymer layer on metallic dendrites;
wherein the metallic dendrites are in contact with the working electrode layer.

2. The biosensor of claim 1, wherein the substrate layer comprises a silicon substrate or a glass substrate.

3. The biosensor of claim 1, wherein the substrate layer has a thickness of about 200 μm to about 500 μm.

4. The biosensor of claim 1, wherein the adhesion layer comprises tungsten, titanium, chromium, nickel, or combinations thereof.

5. The biosensor of claim 1, wherein the adhesion layer has a thickness of about 5 nm to about 20 nm.

6. The biosensor of claim 1, wherein the working electrode layer comprises gold, silver, palladium, platinum, copper, titanium, or combinations thereof.

7. The biosensor of claim 1, wherein the working electrode layer has a thickness of about 50 nm to about 200 nm.

8. The biosensor of claim 1, wherein the conductive polymer layer comprises poly(2-cyanoethyl)pyrrole.

9. The biosensor of claim 1, wherein the metallic dendrite is a metallic pillared dendrite.

10. The biosensor of claim 1, wherein the metallic dendrite comprises gold, silver, palladium, platinum, copper, titanium, or combinations thereof.

11. The biosensor of claim 1, wherein the aggregate thickness of the working electrode layer and the dendrite layer is from about 1 μm to about 100 μm.

12. A method of making the biosensor of claim 1, the method comprising:
fabricating metallic dendrites on a working electrode layer;
wherein fabricating comprises electrodeposition a two-electrode system comprising a working electrode and a counter electrode in an electrolyte solution;
wherein the working electrode layer acts as the working electrode; and
wherein electrodeposition is carried out using a waveform generator.

13. The method of claim 12, wherein the working electrode layer comprises gold; and wherein the electrolyte solution comprises a gold salt.

14. The method of claim 13, wherein the gold salt is HAuCl₄; and wherein the electrolyte solution is present at concentration of about 10 mM to about 50 mM.

15. The method of claim 12, wherein the waveform generator utilizes a frequency of about 10 MHz to about 50 MHz; a square or triangle waveform shape; a peak-to-peak of about 10 V to about 16 V; a peak-to-peak amplitude of about 1/9 to about 1/7; a duty cycle of about 40% to about 60%; and a duration of about 10 minutes to about 20 minutes.

16. The method of claim 12, wherein the metallic dendrites formed are metallic pillared dendrites.

17. The method of claim 12, further comprising forming a conductive polymer layer on the metallic dendrites.

18. The method of claim 17, wherein forming the conductive polymer layer on the metallic dendrites comprises immersing the working electrode layer comprising metallic dendrites thereon in a reaction solution comprising conductive polymer monomers and an electrolyte; wherein the conductive polymer monomers are (2-cyano)pyrrole present at a concentration of about 5 mM to about 30 mM; wherein the electrolyte is NaClO₄ present at a concentration of 10 mM to about 200 mM; and wherein a voltage of about 500 mV to about 1000 mV is applied for about 10 seconds to about 200 seconds.

19. A method of detecting analyte, the method comprising:
contacting a detection complex bound to the biosensor of claim 1; and
carrying out differential pulse voltammetry in the presence of a detection substrate;
wherein the detection complex comprises a primary analyte antibody in contact with the biosensor and the analyte; a secondary analyte antibody in contact with the analyte; and a tertiary detection antibody in contact with the secondary analyte antibody.

20. The method of claim 19, wherein the analyte is cholera toxin; wherein each of the primary analyte antibody and the secondary analyte antibody recognize cholera toxin; wherein the tertiary detection antibody comprises a tertiary antibody and a detection enzyme; wherein tertiary antibody recognizes the secondary analyte antibody; wherein detection enzyme is an alkaline phosphatase; and wherein the detection substrate is p-aminophenylphosphate.
